(19) United States
(12) Patent Application Publication
(10) Pub. No.: US 2019/0072819 A1
(43) Pub. Date: Mar. 7, 2019

(54) HALF MIRROR AND MIRROR WITH IMAGE DISPLAY FUNCTION

(71) Applicant: FUJIFILM Corporation, Tokyo (JP)

(72) Inventors: Akihiro ANZAI, Minamiashigara-shi (JP); Hiroshi INADA, Minamiashigara-shi (JP); Wataru MAJIMA, Minamiashigara-shi (JP); Takao TAGUCHI, Minamiashigara-shi (JP)

(73) Assignee: FUJIFILM Corporation, Tokyo (JP)

(21) Appl. No.: 16/172,192

(22) Filed: Oct. 26, 2018

Related U.S. Application Data
(63) Continuation of application No. PCT/JP2017/009980, filed on Mar. 13, 2017.

(30) Foreign Application Priority Data
May 31, 2016 (JP) 2016-108561
Jun. 21, 2016 (JP) 2016-122604

(51) Int. Cl. G02F 1/1335; G02F 1/13363

(52) U.S. Cl. CPC G02F 1/133555; G02F 1/133536; G02F 1/13363; G02F 2001/133557; B60R 1/12; G02F 2001/133638; G02F 2202/023; G02F 2202/28; G02F 2201/343; G02F 2001/133541

(57) ABSTRACT

A half mirror includes a circularly polarized light reflecting layer including a cholesteric liquid crystal layer, a barrier layer, a bonding layer, and a front panel. The barrier layer, which is, for example, a layer formed by curing a composition containing a urethane (meth)acrylate monomer, is disposed between the bonding layer and the circularly polarized light reflecting layer.

### CROSS-REFERENCE TO RELATED APPLICATIONS

This application is a Continuation of PCT International Application No. PCT/JP2017/009980, filed on Mar. 13, 2017, which claims priority under 35 U.S.C. § 119(a) to Japanese Patent Application No. 2016-108561, filed on May 31, 2016 and Japanese Patent Application No. 2016-122604, filed on Jun. 21, 2016. Each of the above application(s) is hereby expressly incorporated by reference, in its entirety, into the present application.

### BACKGROUND OF THE INVENTION

### 1. Field of the Invention

The present invention relates to a half mirror and a mirror with an image display function.

### 2. Description of the Related Art

For example, JP2014-201146A and JP2011-45427A disclose mirrors with image display functions each including a half mirror provided on a surface of an image display unit of an image display device. In display mode, the mirrors display images, and in non-display mode, such as when the image display devices are turned off, the mirrors serve as mirrors and display mirror-reflected images.

JP2014-201146A discloses a configuration in which a liquid crystal display device is provided in a housing of a vehicle mirror, and images are displayed through a half mirror provided on the front surface of the vehicle mirror, thus enabling the mirror to display the images.

JP2011-45427A discloses a mirror with an information display function used for interiors, makeup, crime prevention, and security.

### SUMMARY OF THE INVENTION

When a half mirror is disposed on an image display unit of an image display device, part of light for image display may fail to pass through the half mirror, thus leading to dark images. When a half mirror is disposed on an image display unit of an image display device, the quality of images may be reduced due to, for example, changes in the shade of the images under the influence of the optical properties of the half mirror itself JP2014-201146A does not focus on these problems. On the other hand, JP2011-45427A describes using a reflective polarizing plate as a half mirror and aligning linearly polarized light emitted from an image display device with the transmission axis of the reflective polarizing plate to prevent light loss and further improve the quality of images. However, such a configuration in which a reflective polarizing plate is used as a half mirror may disadvantageously create a direction in which images and mirror-reflected images cannot be observed through polarizing sunglasses.

An object of the present invention is to provide a mirror with an image display function that allows displayed images and mirror-reflected images to be observed without direction dependency even through polarizing sunglasses and that is capable of displaying images that are bright and have good shades. Another object of the present invention is to provide a half mirror that provides such an mirror with an image display function.

To solve the above problems, the inventors have studied the use of a cholesteric liquid crystal layer for a half mirror. This is because the use of a cholesteric liquid crystal layer having circularly polarized light reflectivity allows displayed images and mirror-reflected images to be observed without direction dependency even through polarizing sunglasses. The inventors have further discovered that by disposing a quarter-wave plate between the cholesteric liquid crystal layer and an image display device, linearly polarized light emitted from the image display device can be used without loss.

However, another problem has been encountered in that a half mirror having such a configuration provides mirror-reflected images that may undergo changes in shade in a high-temperature environment. Such changes in shade may be a serious problem particularly when the half mirror is used for a vehicle since it will probably be used at high temperature.

The inventors have further studied to solve this problem, thereby completing the present invention.

Thus, the present invention provides [1] to [17] below.

[1] A half mirror including a circularly polarized light reflecting layer including a cholesteric liquid crystal layer, a barrier layer, a bonding layer, and a front panel,

wherein the barrier layer is disposed between the bonding layer and the circularly polarized light reflecting layer.

[2] The half mirror according to [1], wherein the circularly polarized light reflecting layer and the barrier layer are in direct contact with each other.
[3] The half mirror according to [1] or [2], wherein the cholesteric liquid crystal layer is a layer formed by curing a liquid crystal composition containing a polymerizable liquid crystal compound and a polymerization initiator.
[4] The half mirror according to [3], wherein the barrier layer inhibits the polymerization initiator in the cholesteric liquid crystal layer or a decomposition product of the polymerization initiator from transferring to the bonding layer.
[5] The half mirror according to [3] or [4], wherein the polymerization initiator is an acylphosphine oxide compound or an oxime compound.
[6] The half mirror according to any one of [1] to [5], wherein the bonding layer is formed of a sheet-shaped adhesive.
[7] The half mirror according to any one of [1] to [6], wherein the barrier layer is a layer formed by curing a composition containing a polymerizable-group-containing monomer.
[8] The half mirror according to [7], wherein Y₁ and X₁ satisfy inequality 1:

Y₁<−300X₁+7.5 (1)

wherein Y₁ is the number of polymerizable groups in the monomer, and X₁ is a polymerizable group content calculated by dividing the number of polymerizable groups Y₁ by a molecular weight of the monomer.
[9] The half mirror according to [7] or [8], wherein the monomer is at least one monomer selected from the group consisting of urethane (meth)acrylate monomers and epoxy monomers.
[10] The half mirror according to [7] to [9], wherein the monomer is a urethane (meth)acrylate monomer, and

the composition contains a urethane polymer.

[11] The half mirror according to [7] to [10], wherein the monomer is a urethane (meth)acrylate monomer, and Y₂ and X₂ satisfy inequality 2:

Y₂>−0.0066X₂+5.33 (2)

wherein Y₂ is the number of polymerizable groups in the urethane (meth)acrylate monomer, and X₂ is a glass transition temperature of the composition.
[12] The half mirror according to [7] to [9], wherein the monomer is an epoxy monomer, and Y₃ and X₃ satisfy inequality 3:

Y₃>−0.01X₃+2.75 (2)

wherein Y₃ is the number of polymerizable groups in the epoxy monomer, and X₃ is a glass transition temperature of the composition.
[13] The half mirror according to any one of [1] to [12], wherein the circularly polarized light reflecting layer includes three or more cholesteric liquid crystal layers.
[14] The half mirror according to any one of [1] to [13], further including a quarter-wave plate,

wherein the quarter-wave plate, the circularly polarized light reflecting layer, and the front panel are disposed in this order.

[15] The half mirror according to [14], wherein the circularly polarized light reflecting layer and the quarter-wave plate are in direct contact with each other.
[16] A mirror with an image display function, the mirror including the half mirror according to any one of [1] to [15] and an image display device, wherein the image display device, the circularly polarized light reflecting layer, and the front panel are disposed in this order.
[17] The mirror with an image display function according to [16], wherein the mirror is used for a vehicle.

The present invention provides a novel half mirror and a mirror with an image display function including the half mirror. By using the half mirror according to the present invention, bright display images and mirror-reflected images can be observed without direction dependency even through polarizing sunglasses. In addition, a mirror with an image display function that causes no change in shade in a high-temperature environment can be provided.

### BRIEF DESCRIPTION OF THE DRAWINGS

FIGS. 1A to 1G schematically illustrate exemplary layer structures of a half mirror; and

FIG. 2A is a graph of TOF-SIMS results showing a substance distribution in the thickness direction of a laminate including a circularly polarized light reflecting layer and a bonding layer, as measured before and after the laminate is left to stand at a high temperature. This graph shows a distribution of a polymerization initiator. FIG. 2B is a graph of TOF-SIMS results showing a substance distribution in the thickness direction of the laminate including a circularly polarized light reflecting layer and a bonding layer, as measured before and after the laminate is left to stand at a high temperature. This graph shows a distribution of a decomposition product of the polymerization initiator.

### DESCRIPTION OF THE PREFERRED EMBODIMENTS

The present invention will now be described in detail.

In this specification, the expression “. . . to . . . ” is meant to include the numerical values before and after “to” as the lower and upper limits.

In this specification, expressions related to angles, such as “45°”, “parallel”, “perpendicular”, and “orthogonal”, imply that the difference from the exact angle is less than 5° unless otherwise specified. The difference from the exact angle is preferably less than 4°, more preferably less than 3°.

In this specification, the term “(meth)acrylate” is used to mean “one or both of acrylate and methacrylate”.

In this specification, the term “selective” used in the context of circular polarization means that the light quantity of one of the right-handed circularly polarized component or the left-handed circularly polarized component is greater than that of the other circularly polarized component. Specifically, when the term “selective” is used, the degree of circular polarization of light is preferably 0.3 or more, more preferably 0.6 or more, still more preferably 0.8 or more, further still more preferably substantially 1.0. The degree of circular polarization is a value expressed by |I_{R}-I_{L}|/(I_{R}+I_{L}) where I_{R} is an intensity of the right-handed circularly polarized component of light, and I_{L} is an intensity of the left-handed circularly polarized component.

In this specification, the term “sense” used in the context of circular polarization means that the circular polarization is right-handed or left-handed. The sense of circular polarization is defined as follows: when light is viewed such that it travels toward the viewer, if the end point of an electric field vector circulates clockwise with time, the circular polarization is right-handed, and if the end point circulates counterclockwise, the circular polarization is left-handed.

In this specification, the term “sense” may be used in the context of the twisted direction of the helix of a cholesteric liquid crystal. When the twisted direction (sense) of the helix of a cholesteric liquid crystal is right, right-handed circularly polarized light is reflected, and left-handed circularly polarized light is transmitted. When the sense of the helix of a cholesteric liquid crystal is left, left-handed circularly polarized light is reflected, and right-handed circularly polarized light is transmitted.

Visible light is a type of electromagnetic radiation that has wavelengths visible to the human eye and is in the wavelength range of 380 nm to 780 nm. Infrared radiation (infrared light) is electromagnetic radiation with wavelengths longer than those of visible light and shorter than those of radio waves. Among the types of infrared radiation, near-infrared light is electromagnetic radiation in the wavelength range of 780 nm to 2,500 nm.

In this specification, a surface of a half mirror on the front panel side relative to a circularly polarized light reflecting layer and a surface of a mirror with an image display function on the front panel side relative to a circularly polarized light reflecting layer may each be referred to as a front surface.

In this specification, the term “image” in the context of a mirror with an image display function refers to an image that is visually observable at the front surface when the image is displayed by an image display unit of an image display device. In this specification, the term “mirror-reflected image” in the context of a mirror with an image display function refers to an image that is visually observable at the front surface when no images are displayed by an image display unit of an image display device.

In this specification, values of front retardation are measured using an AxoScan manufactured by Axometrics. Values of front retardation may also be measured using a KOBRA 21ADH or WR (manufactured by Oji Scientific Instruments) by casting light having a wavelength in the visible light wavelength range, such as a selective reflection center wavelength of a cholesteric liquid crystal layer, in the direction normal to the film. The measurement wavelength can be selected by manually changing a wavelength selective filter, or the measured value can be converted, for example, by using a program. In this specification, front retardation may also be referred to as “Re”.

In this specification, a “reflectance” at a predetermined wavelength is a reflectance value measured using a spectrophotometer at any of the wavelengths described above. Specifically, the reflectance at any of the wavelengths can be measured using a V-670 spectrophotometer (manufactured by JASCO Corporation).

### Half Mirror

A half mirror according to the present invention includes a circularly polarized light reflecting layer, a bonding layer, and a front panel. The half mirror according to the present invention may include, in sequence, a circularly polarized light reflecting layer, a bonding layer, and a front panel or, in sequence, a bonding layer, a circularly polarized light reflecting layer, and a front panel.

The half mirror according to the present invention may be a half mirror with a polarizer, the half mirror including, in sequence, a front panel, a circularly polarized light reflecting layer, and the polarizer.

The half mirror according to the present invention further includes a barrier layer between the circularly polarized light reflecting layer and the bonding layer. The half mirror may include other bonding layers in addition to the above bonding layer or other layers such as a quarter-wave plate.

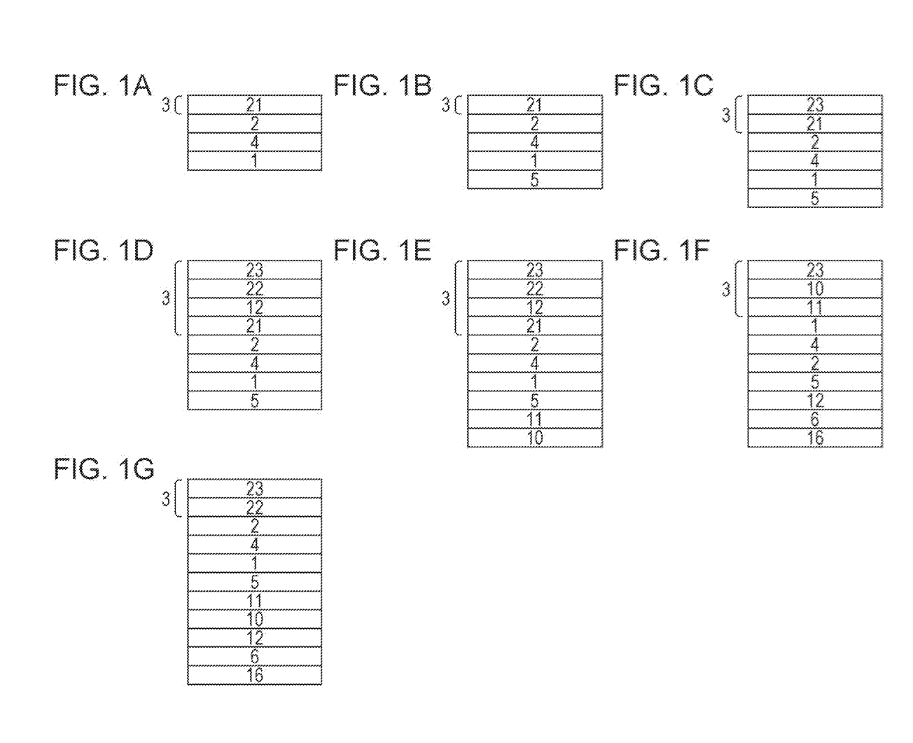

FIGS. 1A to 1G schematically illustrate exemplary layer structures of the half mirror according to the present invention.

FIG. 1A illustrates a structure including a glass substrate or plastic film as a front panel, a bonding layer between the front panel and a circularly polarized light reflecting layer, and, in addition, a barrier layer between the bonding layer and the circularly polarized light reflecting layer.

FIG. 1B illustrates a structure further including a quarter-wave plate in addition to the structure of FIG. 1A.

FIG. 1C illustrates a structure in which a front panel includes an optically functional layer.

FIG. 1D illustrates a structure in which a laminate of a high-Re retardation film and an optically functional layer is bonded to a surface of a glass substrate or plastic film.

FIG. 1E illustrates a structure including, on the outside of a circularly polarized light reflecting layer and a quarter-wave plate, an alignment layer and a support that are used in forming the quarter-wave plate.

FIGS. 1F and 1G each illustrate an exemplary layer structure of a half mirror with a polarizer.

In FIG. 1F, a front panel is constituted by a support and an alignment layer that are used in forming a circularly polarized light reflecting layer and an optically functional layer formed on a surface of the support. A barrier layer is formed on a surface of the circularly polarized light reflecting layer. A quarter-wave plate is bonded to the barrier layer, and a polarizer is bonded to the quarter-wave plate. The barrier layer is disposed on the polarizer side of the circularly polarized light reflecting layer.

The area of the major surface of the front panel may be larger than, equal to, or smaller than the area of the major surface of the circularly polarized light reflecting layer. In this specification, the term “main surface” refers to a surface (front or rear surface) of a plate-like or film-like member. The circularly polarized light reflecting layer may be bonded to a part of the major surface of the front panel, and another type of reflecting layer such as metal foil may be bonded to or formed on the other part. Such a configuration enables an image display at a part of the mirror. Alternatively, the circularly polarized light reflecting layer may be bonded to the entire major surface of the front panel.

The half mirror may have any thickness, but preferably has a thickness of 100 μm to 20 mm, more preferably 200 μm to 15 mm, still more preferably 300 μm to 10 mm.

The half mirror may be plate-like or film-like and may have a curved surface. The half mirror may be flat or curved. Such a curved half mirror can be fabricated using a curved front panel.

### Circularly Polarized Light Reflecting Layer

When the half mirror is used for a mirror with an image display function, the circularly polarized light reflecting layer, at the time of displaying an image, functions to transmit the light emitted from an image display device to thereby display the image on the front surface of the mirror with an image display function, whereas not at the time of displaying an image, the circularly polarized light reflecting layer functions to reflect at least part of incident light from the front surface so that the front surface of the mirror with an image display function serves as a mirror.

Due to the presence of the circularly polarized light reflecting layer in the half mirror, incident light from the front surface can be reflected in the form of circularly polarized light, whereas incident light from the image display device can be transmitted in the form of circularly polarized light. Thus, a mirror with an image display function including the half mirror according to the present invention, even through polarizing sunglasses, allows the observation of displayed images and mirror-reflected images regardless of the relation between the transmission axis direction of the polarizing sunglasses and the horizontal direction of the mirror with an image display function.

The circularly polarized light reflecting layer includes a cholesteric liquid crystal layer. The circularly polarized light reflecting layer preferably includes at least three cholesteric liquid crystal layers. The circularly polarized light reflecting layer may include four or more cholesteric liquid crystal layers. The circularly polarized light reflecting layer may include other layers such as an alignment layer in addition to the cholesteric liquid crystal layers or may be composed solely of the cholesteric liquid crystal layers. The plurality of cholesteric liquid crystal layers are preferably each in direct contact with their adjacent cholesteric liquid crystal layers.

The circularly polarized light reflecting layer preferably has a thickness in the range of 2.0 μm to 300 μm, more preferably in the range of 6.0 μm to 100 μm.

### Cholesteric Liquid Crystal Layer

In this specification, a cholesteric liquid crystal layer refers to a layer in which a cholesteric liquid crystalline phase is fixed. The cholesteric liquid crystal layer may be referred to simply as the liquid crystal layer.

The cholesteric liquid crystalline phase is known to exhibit circularly polarized light selective reflection, that is, to selectively reflect circularly polarized light of one sense, either right-handed circularly polarized light or left-handed circularly polarized light, and selectively transmit circularly polarized light of the opposite sense in a specific wavelength range. In this specification, circularly polarized light selective reflection may be referred to simply as selective reflection.

As films that exhibit circularly polarized light selective reflection and include layers in which the cholesteric liquid crystalline phase is fixed, many films formed of compositions containing polymerizable liquid crystal compounds have been conventionally known. Regarding the cholesteric liquid crystal layers, refer to the related art thereof.

The cholesteric liquid crystal layer may be any layer in which the alignment of a liquid crystal compound forming a cholesteric liquid crystalline phase is maintained. Typically, the cholesteric liquid crystal layer may be a layer having no fluidity formed by bringing a polymerizable liquid crystal compound into the state of cholesteric liquid crystalline phase alignment and then polymerizing and curing the compound, for example, by UV irradiation or heating so that the state of alignment will not be changed by an external field or external force. In the cholesteric liquid crystal layer, it is only necessary that the optical properties of the cholesteric liquid crystalline phase be maintained in the layer, and the liquid crystal compound in the layer need not exhibit liquid crystallinity. For example, the polymerizable liquid crystal compound may lose its liquid crystallinity as a result of an increase in molecular weight due to curing reaction.

The cholesteric liquid crystal layer has a selective reflection center wavelength λ that depends on the pitch P (=helical period) of a helical structure in a cholesteric phase and that satisfies the relation λ=n×P, where n is an average refractive index of the cholesteric liquid crystal layer.

The selective reflection center wavelength and the half-width of the cholesteric liquid crystal layer can be determined as described below. In this specification, the selective reflection center wavelength means a center wavelength measured in the normal direction of the cholesteric liquid crystal layer.

When a reflection spectrum of the cholesteric liquid crystal layer is measured using a V-670 spectrophotometer (Shimadzu Corporation), a reflection peak is observed in a selective reflection band. Of two wavelengths at the reflectance at half the maximum peak height, the wavelength at the short wavelength side is referred to as λₗ (nm), and the wavelength at the long wavelength side as λₕ (nm). The selective reflection center wavelength and the half-width are expressed by the following formulae.

Selective reflection center wavelength=(λₗ+λₕ)/2

Half-width=(λₕ−λₗ)

The reflection spectrum is obtained by applying light at an angle of +5° from the normal direction of the cholesteric liquid crystal layer and observing the cholesteric liquid crystal layer from the specular direction (−5° from the normal direction). The thus-obtained selective reflection center wavelength X of the cholesteric liquid crystal layer is usually in agreement with a wavelength at the centroid of a reflection peak in a circular polarization reflection spectrum measured from the normal direction of the cholesteric liquid crystal layer.

As can be seen from the above formula λ=n×P, the selective reflection center wavelength can be adjusted by adjusting the pitch of the helical structure. By adjusting the n value and the P value, the center wavelength λ can be adjusted in order to selectively reflect either right-handed circularly polarized light or left-handed circularly polarized light when light having a given wavelength is received.

When light is obliquely incident on the cholesteric liquid crystal layer, the selective reflection center wavelength shifts to the short wavelength side. Thus, n×P is preferably adjusted such that λ calculated according to the formula λ=n×P is longer than the selective reflection wavelength required for image display. When a selective reflection center wavelength, as measured when a light beam passes through a cholesteric liquid crystal layer having a refractive index n₂ at an angle θ₂ from the normal direction of the cholesteric liquid crystal layer (the direction of the helical axis of the cholesteric liquid crystal layer), is referred to as λ_{d}, λ_{d} is expressed by the following formula.

λ_{d}=n₂×P×cosθ₂

By designing the selective reflection center wavelength of the cholesteric liquid crystal layer included in the circularly polarized light reflecting layer taking into account the foregoing, the decrease in image visibility at oblique angles can be prevented.

The pitch of the cholesteric liquid crystalline phase depends on the type or concentration of a chiral agent used with a polymerizable liquid crystal compound, and thus the desired pitch can be achieved by adjusting these conditions. The sense and pitch of a helix can be measured by using methods described in page 46 of “Ekisho Kagaku Jikken Nyumon (Introduction of Liquid Crystal Chemical Experiments)” edited by The Japanese Liquid Crystal Society, published by SIGMA SHUPPAN, 2007 and page 196 of “Handbook of Liquid Crystals” edited by the Editorial Board of the Handbook of Liquid Crystals, published by Maruzen Co., Ltd.

By adjusting the selective reflection center wavelength of the cholesteric liquid crystal layer for use according to the emission wavelength range of the image display device and the conditions for the use of the circularly polarized light reflecting layer, bright images can be displayed with good light use efficiency. Specific examples of the conditions for the use of the circularly polarized light reflecting layer include the angle of light incidence on the circularly polarized light reflecting layer and the direction of image observation.

In the half mirror according to the present invention, the circularly polarized light reflecting layer preferably includes a cholesteric liquid crystal layer having a selective reflection center wavelength in the red light wavelength range, a cholesteric liquid crystal layer having a selective reflection center wavelength in the green light wavelength range, and a cholesteric liquid crystal layer having a selective reflection center wavelength in the blue light wavelength range. For example, the reflecting layer preferably includes a cholesteric liquid crystal layer having a selective reflection center wavelength in the range of 400 nm to 500 nm, a cholesteric liquid crystal layer having a selective reflection center wavelength in the range of 500 nm to 580 nm, and a cholesteric liquid crystal layer having a selective reflection center wavelength in the range of 580 nm to 700 nm.

When the circularly polarized light reflecting layer includes a plurality of cholesteric liquid crystal layers, the cholesteric liquid crystal layer closer to the image display device preferably has a longer selective reflection center wavelength. With this configuration, the change in shade is less likely to occur when images and mirror-reflected images are obliquely observed.

To prevent a change in shade of mirror-reflected images, the circularly polarized light reflecting layer may include a cholesteric liquid crystal layer having a selective reflection center wavelength in the infrared range. In this case, the selective reflection center wavelength in the infrared range may be specifically in the range of 780 to 900 nm, preferably 780 to 850 nm. If such a cholesteric liquid crystal layer having a selective reflection center wavelength in the infrared range is provided, it is preferably located nearer to the image display device than any of the cholesteric liquid crystal layers having selective reflection center wavelengths in the visible range.

Furthermore, when the half mirror used for a mirror with an image display function does not include, particularly, a quarter-wave plate, the selective reflection center wavelength of each cholesteric liquid crystal layer is preferably different from the light emission peak wavelength of the image display device by 5 nm or more. More preferably, the difference is 10 nm or more. Such a difference between the selective reflection center wavelength and the light emission peak wavelength for image display of the image display device prevents light for image display from being reflected by the cholesteric liquid crystal layer, and as a result, a bright display image can be provided. The light emission peak wavelength of the image display device can be determined by an emission spectrum of the image display device at the time of white display. The peak wavelength may be a peak wavelength in the visible range of the emission spectrum. For example, the peak wavelength may be at least one selected from the group consisting of a red light emission peak wavelength λR, a green light emission peak wavelength λG, and a blue light emission peak wavelength λB of the image display device. The selective reflection center wavelength of each cholesteric liquid crystal layer is preferably different from the red light emission peak wavelength λR, the green light emission peak wavelength λG, and the blue light emission peak wavelength λB of the image display device all by 5 nm or more, more preferably 10 nm or more. When the circularly polarized light reflecting layer includes a plurality of cholesteric liquid crystal layers, the selective reflection center wavelengths of all the cholesteric liquid crystal layers may be set to be different from the peak wavelength of light emitted from the image display device by 5 nm or more, preferably 10 nm or more. For example, when the image display device is a full-color display device that has a red light emission peak wavelength λR, a green light emission peak wavelength λG, and a blue light emission peak wavelength λB in its emission spectrum at the time of white display, all the selective reflection center wavelengths of the cholesteric liquid crystal layers may be set to be different from λR, λG, and λB by 5 nm or more, preferably 10 nm or more.

Furthermore, when the circularly polarized light reflecting layer includes three cholesteric liquid crystal layers having different selective reflection center wavelengths represented by λ1, λ2, and λ3, the relation λB<λ1<λG<λ2<λR<λ3 is preferably satisfied.

Each cholesteric liquid crystal layer has either a right-handed or left-handed helical sense. The sense of reflected circularly polarized light of each cholesteric liquid crystal layer is in agreement with its helical sense. The helical senses of the plurality of cholesteric liquid crystal layers are preferably all the same. In the case of a half mirror including a quarter-wave plate, the helical sense may be determined, for each cholesteric liquid crystal layer, depending on the sense of circularly polarized light included in a larger quantity in the light that has just passed through the quarter-wave plate after exiting the image display device. Specifically, cholesteric liquid crystal layers may be used having helical senses that allow the passage of circularly polarized light having a sense included in a larger quantity in the light that has just passed through the quarter-wave plate after exiting the image display device.

The half-width Δλ (nm) of a selective reflection band where selective reflection is exhibited depends on the birefringence Δn of the liquid crystal compound and the above-described pitch P and satisfies the relation Δλ=Δn×P. Therefore, the width of the selective reflection band can be controlled by adjusting Δn. An can be adjusted by adjusting the type and mixing ratio of polymerizable liquid crystal compound or by controlling the temperature at which the alignment is fixed.

To form cholesteric liquid crystal layers of the same type having the same selective reflection center wavelength, a plurality of cholesteric liquid crystal layers having the same pitch P and the same helical sense may be stacked on top of each other. Stacking cholesteric liquid crystal layers having the same pitch P and the same helical sense on top of each other can increase the circular polarization selectivity at a particular wavelength.

### Front Panel

The half mirror according to the present invention includes a front panel.

The front panel may be plate-like or film-like and may have a curved surface. The front panel may be flat or curved. Such a curved front panel can be produced, for example, by plastic processing such as injection molding. In injection molding, for example, raw plastic pellets are melted by heat, injected into a mold, and then solidified by cooling, whereby a resin product can be obtained.

Preferably, the front panel is directly bonded to the circularly polarized light reflecting layer with a bonding layer, or the front panel and the circularly polarized light reflecting layer are in direct contact with each other.

The front panel may be made of any material. The front panel may include a glass plate or plastic film used to produce a standard mirror.

Examples of plastic film materials include polycarbonates, acrylic resins, epoxy resins, polyurethanes, polyamides, polyolefins, cellulose derivatives such as triacetylcellulose, silicones, polyesters such as polyethylene terephthalate (PET), polyacetals, and polyarylates. A support used in forming a cholesteric liquid crystal layer may be used as the front panel. In this case, the front panel may include an alignment layer.

The front panel may have a thickness of about 100 μm to 10 mm, preferably 200 μm to 5 mm, more preferably 500 μm to 2 mm, still more preferably 500 μm to 1,000 μm.

The front panel may include a high-Re retardation film. The above-described plastic film may serve as a high-Re retardation film. Alternatively, the front panel may include a high-Re retardation film in addition to a glass plate or a plastic film that is not a high-Re retardation film. The front panel may also include an optically functional layer.

### High-Re Retardation Film

In this specification, the term “high-Re retardation film” refers to a retardation film that has a high front retardation and that is distinguished from a quarter-wave plate (retardation plate). The front retardation of the high-Re retardation film is preferably 3,000 nm or more, more preferably 5,000 nm or more. The front retardation of the high-Re retardation film is preferably as high as possible, but in view of production efficiency and thinness, the front retardation may be 100,000 nm or less, 50,000 nm or less, 40,000 nm or less, or 30,000 nm or less.

When the half mirror according to the present invention is used for a mirror with an image display function, the high-Re retardation film can prevent brightness unevenness or color unevenness that may occur in a mirror-reflected image or a display image.

Brightness unevenness or color unevenness may occur in a mirror-reflected image due to the following reason, for example.

Tempered glass (e.g., tempered glass not having a glass laminate structure) used for window panes, particularly, for rear window panes of vehicles is known to have birefringence distribution. This is probably because brightness unevenness or color unevenness occurs in a mirror-reflected image formed by light incident on the front surface of a mirror with an image display function, for example, through a rear window pane of a vehicle. Specifically, the birefringence distribution causes the light incident on the front surface of the mirror with an image display function to have a polarized component with distribution, and as a result, reflected light at the front surface (outermost surface) of the mirror with an image display function and selectively reflected light at a circularly polarized light reflecting layer interfere with each other to produce a difference in reflected light intensity, which is probably because brightness unevenness or color unevenness may occur. The high-Re retardation film can convert light incident on the front surface of the mirror with an image display function into quasi-unpolarized light before the light is incident on the reflecting layer, thereby reducing the brightness unevenness or color unevenness.

Front retardations that can convert polarized light into quasi-unpolarized light are described in paragraphs 0022 to 0033 of JP2005-321544A.

The high-Re retardation film may be a birefringent material such as a plastic film or a quartz plate. Examples of plastic films include polyester films such as polyethylene terephthalate (PET), polycarbonate films, polyacetal films, and polyarylate films. Regarding retardation films including PET and having high retardations, refer to JP2013-257579A and JP2015-102636A, for example. Commercially available products such as a Cosmoshine (registered trademark) Super Retardation Film (Toyobo Co., Ltd.) may be used.

A plastic film having a high retardation can be typically formed by melt-extruding a resin, casting the extrudate onto a drum or the like into film form, and uniaxially or biaxially stretching the film at a stretching ratio of 2 to 5 under heating. After the stretching, a heat treatment called “heat setting” may be performed at a temperature higher than the stretching temperature in order to promote crystallization and increase the strength of the film.

### Optically Functional Layer

Examples of optically functional layers include hard coat layers, antiglare layers, antireflection layers, and antistatic layers.

The optically functional layer is preferably a cured polymerizable composition layer disposed on a glass plate or plastic film. In the half mirror according to the present invention, the optically functional layer, the glass plate or plastic film, and the circularly polarized light reflecting layer are preferably disposed in this order.

### Hard Coat Layer

The hard coat layer may be the outermost layer of the half mirror, or another layer may be disposed outside the hard coat layer.

In this specification, the hard coat layer is a layer that, if formed, increases the pencil hardness of the half mirror surface. Specifically, the hard coat layer is a layer that, after being formed, increases the pencil hardness (JIS K5400) to H or higher. The pencil hardness measured after the hard coat layer is formed is preferably 2H or higher, more preferably 3H or higher. The hard coat layer preferably has a thickness of 0.1 μm to 100 μm, more preferably 1.0 μm to 70 μm, still more preferably 2.0 μm to 50 μm.

The hard coat layer may also serve as an antireflection layer or an antistatic layer.

Specifically, the hard coat layer may be a layer formed of a composition containing a UV-curable polymerizable compound. The composition may contain other components such as particles. The UV-curable polymerizable compound is preferably a (meth)acrylate. Regarding the materials and production methods for the hard coat layer, refer to JP2016-071085A, JP2012-168295A, and JP2011-225846A, for example.

### Antiglare Layer

The antiglare layer is a layer for imparting anti-glare characteristics against surface scattering. The antiglare layer may be the outermost layer of the half mirror, or another layer may be disposed outside the antiglare layer.

The antiglare layer can be formed of a composition containing a binder-resin-forming compound for antiglare layers and particles for antiglare layers.

Regarding the materials and production methods for the antiglare layer, refer to the description of 0101 to 0109 of JP2013-178584A and JP2016-053601A, for example.

### Antireflection Layer

The antireflection layer is preferably disposed at the outermost surface of the half mirror. The antireflection layer suppresses light reflection at the outermost surface and enables clear observation of mirror-reflected images based on images formed by light from a polarized light reflecting plate. Regarding the materials and production methods for the antireflection layer, refer to the description of 0049 to 0053 of WO2015/050202.

### Antistatic Layer

The antistatic layer is preferably disposed at the outermost surface of the half mirror. Regarding the materials and production methods for the antistatic layer, refer to the description of 0020 to 0028 of JP2012-027191A.

### Bonding Layer

The half mirror according to the present invention includes a bonding layer for bonding the circularly polarized light reflecting layer and the front panel together. The bonding layer for bonding the circularly polarized light reflecting layer and the front panel together is a bonding layer interposed between the circularly polarized light reflecting layer and the front panel.

The bonding layer may be formed of an adhesive containing a compound such as an acrylate compound, a urethane compound, a urethane acrylate compound, an epoxy compound, an epoxy acrylate compound, a polyolefin compound, a modified olefin compound, a polypropylene compound, an ethylene vinyl alcohol compound, a vinyl chloride compound, a chloroprene rubber compound, a cyanoacrylate compound, a polyamide compound, a polyimide compound, a polystyrene compound, or a polyvinyl butyral compound. From the viewpoint of optical transparency and heat resistance, an acrylate compound, a urethane acrylate compound, and an epoxy acrylate compound are preferred. According to the type of setting, adhesives are classified into hot melt adhesives, thermosetting adhesives, photosetting adhesives, reaction-setting adhesives, and pressure-sensitive adhesives requiring no setting. From the viewpoint of workability and productivity, the type of setting is preferably photosetting.

A bonding layer for bonding the circularly polarized light reflecting layer and any other layer (e.g., the front panel, the quarter-wave plate, or the polarizer) together is preferably not of hot-melt type. In other words, the bonding layer is preferably not a thermoplastic melt-bonding layer. The thermoplastic melt-bonding layer is a layer that is melted by heating and then cooled to bond two layers together.

More preferably, the bonding layer for bonding the circularly polarized light reflecting layer and any other layer together is formed of a pressure-sensitive adhesive requiring no setting. Examples of preferred pressure-sensitive adhesives include acrylate adhesives, urethane adhesives, and silicone adhesives. Acrylate adhesives are particularly preferred.

The adhesive may be sheet-shaped or liquid.

Examples of sheet-shaped adhesives include pressure-sensitive adhesives requiring no setting and adhesives used in such a manner that a sheet is placed in position and then thermoset or photoset. When a sheet-shaped adhesive is applied, OCA tape (high-transparency adhesive transfer tape) can be used, for example. OCA tape is typically marketed in the form of an adhesive layer having a protective release sheet on one or both surfaces thereof, and such an adhesive layer can be used as the bonding layer.

Examples of liquid adhesives include optically clear resins (OCRs).

The above-described problem in that mirror-reflected images undergo changes in shade under high-temperature conditions is particularly pronounced when a sheet-shaped adhesive, specifically, an adhesive layer in OCA tape is used as the bonding layer for bonding the circularly polarized light reflecting layer and any other layer together. This is probably because sheet-shaped adhesives generally have low Tg and high fluidity, and thus external substances tend to flow therein in a high-temperature environment. Thus, the effect of providing a barrier layer is particularly pronounced when a sheet-shaped adhesive is used to form the bonding layer.

Examples of sheet-shaped adhesives include acrylate adhesives, urethane adhesives, and silicone adhesives. Acrylate adhesives are particularly preferred.

The OCA tape used as a sheet-shaped adhesive may be a commercially available product for an image display device, particularly, a commercially available product for an image display unit surface of an image display device. Examples of such a commercially available product include adhesive sheets (e.g., PD-S1) manufactured by Panac Corporation, MEM series of adhesive sheets manufactured by Nichiei Kakoh Co., Ltd., and OCA8146 manufactured by 3M.

The bonding layer preferably has a thickness of 0.50 μm or more and 50 μm or less, more preferably 1.0 μm or more and 25 μm or less.

### Barrier Layer

The half mirror according to the present invention includes a barrier layer. The barrier layer is disposed between the bonding layer and the circularly polarized light reflecting layer. The barrier layer and the circularly polarized light reflecting layer are preferably in direct contact with each other. In particular, the barrier layer is preferably in direct contact with a cholesteric liquid crystal layer in the circularly polarized light reflecting layer.

As described above, the inventors have discovered that a half mirror including a cholesteric liquid crystal layer provides mirror-reflected images that undergo changes in shade under high-temperature conditions, particularly, high-temperature high-humidity conditions. For example, changes in shade may occur in an environment at 40° C. to 200° C., particularly, at 65° C. to 110° C. Specifically, changes in shade may occur, for example, in an environment at 40% relative humidity and 85° C. to 110° C. or an environment at 85% relative humidity and 65° C. to 85° C. Such changes in shade result from the shift of the selective reflection center wavelength of the cholesteric liquid crystal layer to the short wavelength side in a high-temperature environment, as will be described later.

The inventors have obtained the result that substances have probably transferred from the cholesteric liquid crystal layer to the bonding layer in a high-temperature environment, as shown in EXAMPLES, and have solved the above problem by providing a barrier layer for inhibiting such a transfer.

While not wishing to be bound by any theory, it is believed that in a half mirror not including a barrier layer, as substances constituting a cholesteric liquid crystal layer transfer outside at a high temperature, the thickness of the cholesteric liquid crystal layer decreases, and the pitch P decreases, with the result that the selective reflection center wavelength shifts to the short wavelength side.

The barrier layer is a layer capable of inhibiting cholesteric liquid crystal layer components from transferring outside in a high-temperature environment. In particular, the barrier layer is preferably a layer capable of inhibiting the cholesteric liquid crystal layer components from transferring to the bonding layer. The barrier layer is preferably a layer to which the cholesteric liquid crystal layer components are less likely to transfer.

Examples of cholesteric liquid crystal layer components that are inhibited from transferring by the barrier layer include polymerization initiators, unreacted polymerizable liquid crystal compounds, and decomposition products thereof. Of these, components selected from the group consisting of polymerization initiators and decomposition products of polymerization initiators are preferably inhibited from transferring.

Being capable of inhibiting transfer means being capable of increasing the amount of components detected in the cholesteric liquid crystal layer to be larger than the amount of components detected in a cholesteric liquid crystal layer of a half mirror having the same structure but not including a barrier layer. The detection in this case may be performed by cutting the half mirror and analyzing the surface of the cholesteric liquid crystal layer. In other words, being capable of inhibiting transfer means being capable of decreasing the amount of cholesteric liquid crystal layer components detected in the barrier layer and the bonding layer to be smaller than the amount of cholesteric liquid crystal layer components detected in the bonding layer of a half mirror having the same structure but not including a barrier layer. The detection in this case may be performed by cutting the half mirror and analyzing the surface of the bonding layer or the surfaces of the barrier layer and the bonding layer. Specifically, the half mirrors are left to stand in a high-temperature environment and then each subjected to the above detection to confirm that the amount of the components has been substantially decreased.

The surface analysis may be performed, for example, by X-ray photoelectron spectroscopy (XPS) or time-of-flight secondary ion mass spectrometry (TOF-SIMS).

The half mirrors may be left to stand in a high-temperature environment at 110° C. for 160 hours.

The barrier layer is preferably transparent in the visible range. Being transparent in the visible range means that the light transmittance in the visible range is 80% or more, preferably 85% or more. The light transmittance used as a measure of transparency is light transmittance determined by a method described in JIS A5759. Specifically, the transmittance is measured at wavelengths of 380 nm to 780 nm with a spectrophotometer and multiplied by a weighting coefficient obtained from the wavelength distribution and wavelength interval of International Commission on Illumination (CIE) photopic spectral luminous efficiency and the spectral distribution of CIE daylight D65, and a weighted average is calculated to determine the light transmittance.

The barrier layer preferably has low birefringence. For example, the front retardation may be 20 nm or less, preferably less than 10 nm, more preferably 5 nm or less.

The barrier layer may be, for example, an inorganic layer or an organic layer.

### Organic Barrier Layer

When the barrier layer is an organic layer, it is preferably a barrier layer formed of a composition having a high glass transition temperature (Tg). This is because such a barrier layer is stable in a high-temperature environment.

In this specification, the glass transition temperature Tg (hereinafter also referred to as “Tg” for short) is determined by differential scanning calorimetry (DSC). One specific example of the DSC measurement conditions is as follows.

DSC apparatus: DSC 6200, manufactured by SII Technology
Atmosphere in measuring chamber: nitrogen (50 mL/min)
Heating rate: 10° C./min
Measurement start temperature: 0° C.
Measurement end temperature: 200° C.
Sample pan: aluminum pan
Mass of test sample: 5 mg
Determination of Tg: The temperature at the midpoint between a descent start point and a descent end point in a DSC chart is used as Tg. The measurement is performed twice on one sample, and the second measurement result is employed.

Specifically, Tg is preferably 80° C. or higher, more preferably 100° C. or higher. Tg is preferably 500° C. or lower, more preferably 300° C. or lower.

The barrier layer is preferably hydrophilic. Specifically, the barrier layer preferably has an SP value (solubility parameter) of 22 to 26, more preferably 23 to 26.

The solubility parameter (SP value) can be determined by the Okitsu method. The Okitsu method is described in detail Journal of the Adhesion Society of Japan, Vol. 29, No. 6 (1993), pp. 249 to 259.

### Layer Formed by Curing Composition Containing Polymerizable-Group-Containing Monomer

The organic barrier layer is preferably a layer formed by curing a composition containing a polymerizable-group-containing monomer.

The monomer may be, for example, a urethane (meth)acrylate monomer, a (meth)acrylate monomer, or an epoxy monomer. The number of polymerizable groups in the monomer is preferably larger. The monomer may be a mixture of two or more monomers.

The urethane (meth)acrylate monomer contains a urethane bond represented by formula (I) and a (meth)acryloyl group.

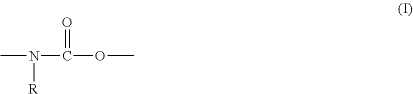

In formula (I), R represents a hydrogen atom or a hydrocarbon group.

In this specification, the term “hydrocarbon group” refers to a monovalent group constituted only by carbon and hydrogen, and examples include alkyl groups, cycloalkyl groups, and aromatic ring groups such as phenyl and naphthyl.

Preferably, R is a hydrogen atom.

The urethane (meth)acrylate monomer is a compound obtained by the addition reaction using a polyisocyanate compound and a hydroxyl-group-containing (meth)acrylate compound or the addition reaction using a polyalcohol compound and an isocyanate-group-containing (meth)acrylate compound.

The polyisocyanate compound is preferably a diisocyanate or a triisocyanate. Specific examples of polyisocyanate compounds include toluene diisocyanate, isophorone diisocyanate, hexamethylene diisocyanate, tolylene diisocyanate, and 1,3-bis(isocyanatomethyl)cyclohexane.

Examples of hydroxyl-containing (meth)acrylate compounds include pentaerythritol triacrylate, dipentaerythritol pentaacrylate, 2-hydroxyethyl acrylate, and 2-hydroxyethyl methacrylate.

Examples of polyalcohol compounds include ethylene glycol, propylene glycol, glycerol, pentaerythritol, dipentaerythritol, trimethylolethane, and trimethylolpropane.

Examples of isocyanate-group-containing (meth)acrylate compounds include 2-isocyanatoethyl acrylate and 2-isocyanatoethyl methacrylate.

The urethane (meth)acrylate monomer preferably contains two or more, more preferably three or more, still more preferably four or more (meth)acryloyl groups. There is no particular upper limit to the number of (meth)acryloyl groups in the urethane (meth)acrylate monomer. The number is preferably 30 or less, more preferably 20 or less, still more preferably 18 or less.

The urethane (meth)acrylate monomer preferably has a molecular weight of 400 to 8,000, more preferably 500 to 5,000.

The urethane (meth)acrylate monomer may be a commercially available product. Examples of such a commercially available product include U-2PPA, U-4HA, U-6LPA, U-10PA, UA-1100H, U-10HA, U-15HA, UA-53H, UA-33H, U-200PA, UA-160TM, UA-290TM, UA-4200, UA-4400, UA-122P, UA-7100, and UA-W2A manufactured by Shin-Nakamura Chemical Co., Ltd., UA-510H, AH-600, AT-600, U-306T, UA-306I, UA-306H, UF-8001G, DAUA-167, BPZA-66, and BPZA-100 manufactured by Kyoeisha Chemical Co., Ltd., and EBECRYL 204, EBECRYL 205, EBECRYL 210, EBECRYL 215, EBECRYL 220, EBECRYL 230, EBECRYL 244, EBECRYL 245, EBECRYL 264, EBECRYL 265, EBECRYL 270, EBECRYL 280/15IB, EBECRYL 284, EBECRYL 285, EBECRYL 294/25HD, EBECRYL 1259, EBECRYL 1290, EBECRYL 8200, EBECRYL 8200AE, EBECRYL 4820, EBECRYL 4858, EBECRYL 5129, EBECRYL 8210, EBECRYL 8254, EBECRYL 8301R, EBECRYL 8307, EBECRYL 8402, EBECRYL 8405, EBECRYL 8411, EBECRYL 8465, EBECRYL 8800, EBECRYL 8804, EBECRYL 8807, EBECRYL 9260, EBECRYL 9270, KRM7735, KRM8296, KRM8452, KRM8904, EBECRYL 8311, EBECRYL 8701, EBECRYL 9227EA, KRM8667, and KRM8528 manufactured by Daicel-Cytec Co., Ltd.

Examples of preferred urethane (meth)acrylate monomers include U-6LPA and U-4HA. Mixtures of U-6LPA or U-4HA, which has a large number of polymerizable groups, with a urethane acrylate resin such as BPZA-66 or BPZA-100 and mixtures of, for example, U-6LPA or U-4HA with, for example, UA122P (manufactured by Shin-Nakamura Chemical Co., Ltd.) are also preferred.

The urethane (meth)acrylate monomer may also be used in combination with a urethane polymer.

The urethane polymer, which is the general term of polymers having a urethane bond in the main chain, is typically obtained by the reaction of a polyisocyanate with a polyol. Examples of polyisocyanates include toluene diisocyanate (TDI), diphenylmethane diisocyanate (MDI), hexamethylene diisocyanate (HDI), and isophorone diisocyanate (IPDI). Examples of polyols include ethylene glycol, propylene glycol, glycerol, and hexanetriol. The urethane polymer may be a polymer obtained by increasing the molecular weight of a polyurethane obtained by the reaction of a polyisocyanate with a polyol by chain extension treatment. Regarding polyisocyanates, polyols, and chain extension treatment, refer to “Polyurethane Resin Handbook” (edited by Keiji Iwata, published by Nikkan Kogyo Shimbun, Ltd., 1987), for example. Commercially available products such as 8BR-600 (manufactured by Taisei Fine Chemical Co., Ltd.) can be used.

The urethane polymer preferably has a molecular weight of 10,000 to 200,000, more preferably 15,000 to 150,000.

When the urethane polymer is used in combination with the urethane (meth)acrylate monomer, the urethane polymer is preferably contained in a composition for barrier layer formation in an amount of 1.0% to 50% by mass, more preferably 10% to 40% by mass, relative to the total mass (solids content) of the composition.

Examples of (meth)acrylate monomers that can be used include compounds described in paragraphs 0024 to 0036 of JP2013-43382A and paragraphs 0036 to 0048 of JP2013-43384A. Polyfunctional acrylic monomers having a fluorene skeleton described in WO2013/047524 can also be used.

The (meth)acrylate monomer is preferably at least one monomer selected from the group consisting of DPHA and ADCP manufactured by Shin-Nakamura Chemical Co., Ltd., SP327 manufactured by Toagosei Co., Ltd., and KAYARAD PET30, KAYARAD DPCA20, DPCA30, DPCA60, and DPCA120 manufactured by Nippon Kayaku Co., Ltd., since they have particularly high Tg and large numbers of polymerizable groups.

The epoxy monomer may be any monomer containing an epoxy group. For example, bisphenol A-type, hydrogenated bisphenol A-type, bisphenol F-type, hydrogenated bisphenol F-type, novolac-type, aromatic, alicyclic, heterocyclic, glycidyl ester-type, and glycidyl amine-type epoxy compounds, glycidyl (meth)acrylates, and triglycidyl isocyanurate can be used.

Examples of commercially available epoxy monomers include EHPE3150, CEL2021P, CEL8000, CYCLOMER M100 (Daicel Corporation), JER1031S, JER157S65, JER1007, JER152, JER154, JERYX6810, JERYX8000 (Mitsubishi Chemical Corporation), DENACOL EX411, DENACOL EX810, DENACOL EX821, DENACOL EX825, DENACOL EX841 (Nagase ChemteX Corporation), EPICLON HP-4032D, EPICLON EXA1514, EPICLON HP-7200, EPICLON HP7200L, EPICLON HP7200H, EPICLON N670, and EPICLON N680.

Of these, CEL2021P, CEL8000, CYCLOMER M100, and EPICLON HP-4032D are particularly preferred.

The monomer is preferably contained in the composition for barrier layer formation in an amount of 50% to 100% by mass, more preferably 80% to 99% by mass, relative to the total mass (solids content) of the composition.

The composition for barrier layer formation may contain a polymerization initiator. When a polymerization initiator is used, the amount thereof is preferably 0.1 mol % or more, more preferably 0.5 to 5 mol % of the total amount of the above monomer. Examples of polymerization initiators include those which can be used for the liquid crystal composition described below and cationic photopolymerization initiators described below. When the monomer used is an epoxy monomer, it is preferable to use a cationic photopolymerization initiator.

Cationic photopolymerization initiators are able to generate cations as active species upon photoirradiation, and specific examples include known sulfonium salts, ammonium salts, iodonium salts (e.g., diaryliodonium salts), triarylsulfonium salts, diazonium salts, and iminium salts. More specific examples include cationic photopolymerization initiators represented by formulae (25) to (28) shown in paragraphs 0050 to 0053 of JP1996-143806A (JP-H8-143806A) and those listed as cationic polymerization catalysts in paragraph 0020 of JP1996-283320A (JP-H8-283320A). Examples of commercially available cationic photopolymerization initiators include CI-1370, CI-2064, CI-2397, CI-2624, CI-2639, CI-2734, CI-2758, CI-2823, CI-2855, and CI-5102 manufactured by Nippon Soda Co., Ltd., PHOTOINITIATOR2047 manufactured by Rhodia Inc., UVI-6974 and UVI-6990 manufactured by Union Carbide Corporation, and CPI-10P manufactured by San-Apro Ltd.

In terms of, for example, the sensitivity of cationic photopolymerization initiators to light and the stability of compounds, diazonium salts, iodonium salts, sulfonium salts, and iminium salts are preferred. In terms of weather resistance, iodonium salts are more preferred.

Specific examples of commercially available iodonium salt cationic photopolymerization initiators include B2380 manufactured by Tokyo Chemical Industry Co., Ltd., BBI-102 manufactured by Midori Kagaku Co., Ltd., WPI-113, WPI-124, WPI-169, and WPI-170 manufactured by Wako Pure Chemical Industries, Ltd., and DTBPI-PFBS manufactured by Toyo Gosei Co., Ltd.

Specific examples of iodonium salt compounds that can be used as cationic photopolymerization initiators include the following compounds PAG-1 and PAG-2.

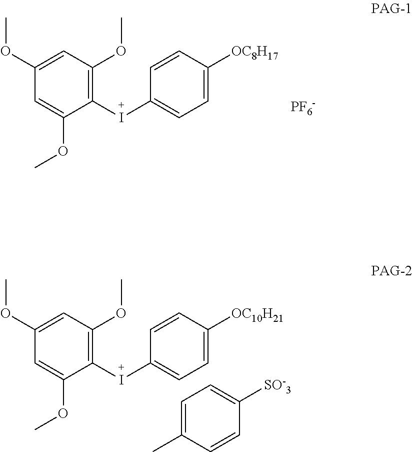

The composition for barrier layer formation may optionally contain other components such as surfactants.

In the composition for barrier layer formation containing the above-described monomer, Y₁ and X₁ preferably satisfy inequality 1:

Y₁<−300X₁+7.5 (1)

wherein Y₁ is the number of polymerizable groups in the monomer in the composition, and X₁ is a polymerizable group content.

The inventors have discovered that the occurrence of cracks in the barrier layer can be more effectively prevented when inequality 1 is satisfied. As can be seen from inequality 1, when the number of polymerizable groups in the monomer is excessively large, cracks tend to occur, and when the molecular weight relative to the number of polymerizable groups is large, cracks tend to occur even if the number of polymerizable groups is smaller. The polymerizable group content is calculated by dividing the number of polymerizable groups in the monomer by the molecular weight (the number of polymerizable groups/molecular weight). When the composition contains a plurality of monomers, Y₁ and X₁ are each an average value obtained taking into account the ratio of the amount of each monomer in the composition to the total amount of the monomers. Therefore, a monomer that does not satisfy inequality 1 by itself is preferably used in combination with another monomer so as to satisfy inequality 1.

When the barrier layer is a layer formed by curing a composition containing a urethane (meth)acrylate monomer, Y₂ and X₂ preferably satisfy inequality 2:

Y₂>−0.0066X₂+5.33 (2)

wherein Y₂ is the number of polymerizable groups in the urethane (meth)acrylate monomer, and X₂ is a glass transition temperature (Tg) of the composition.

The inventors have discovered that the barrier layer has higher heat resistance when inequality 2 is satisfied. Although the number of polymerizable groups in the urethane (meth)acrylate monomer is preferably large, the number of polymerizable groups may be relatively small when Tg is high, as can be seen from inequality 2. When the composition contains a plurality of monomers, Y₂ and X₂ are each an average value obtained taking into account the ratio of the amount of each monomer in the composition to the total amount of the monomers. Therefore, a monomer that does not satisfy inequality 2 by itself is preferably used in combination with another monomer so as to satisfy inequality 2.

When the barrier layer is a layer formed by curing a composition containing an epoxy monomer, Y₃ and X₃ preferably satisfy inequality 3:

Y₃>−0.01X₃+2.758 (3)

wherein Y₃ is the number of polymerizable groups in the epoxy monomer, and X₃ is a glass transition temperature (Tg) of the composition.

The inventors have discovered that the occurrence of cracks in the barrier layer can be more effectively prevented when inequality 3 is satisfied. Although the number of polymerizable groups in the epoxy monomer is preferably large, the number of polymerizable groups may be relatively small when Tg of the composition containing an epoxy monomer is high, as can be seen from inequality 3. When the composition contains a plurality of monomers, Y₃ and X₃ are each an average value obtained taking into account the ratio of the amount of each monomer in the composition to the total amount of the monomers. Therefore, a monomer that does not satisfy inequality 3 by itself is preferably used in combination with another monomer so as to satisfy inequality 3.

The organic barrier layer preferably has a thickness of 0.1 μm or more and 20 μm or less, more preferably 0.5 μm or more and 10 μm or less, still more preferably 1.2 μm or more and 3.0 μm or less.

The barrier layer formation from the above-described composition is preferably performed by a method involving applying the composition for barrier layer formation on a cholesteric liquid crystal layer, preferably, on a surface of the cholesteric liquid crystal layer. The composition for barrier layer formation may contain a solvent for a successful application. The layer formed by the application may be dried and cured by a suitable method depending on the composition used, thereby forming a barrier layer. The curing is preferably photocuring. Regarding the solvent that may be contained in the composition for barrier layer formation, the method of application, and the conditions for photocuring, refer to the description below on liquid crystal compositions.

### Inorganic Barrier Layer

When the barrier layer is an inorganic layer, it preferably has a high density in order to make it difficult for the cholesteric liquid crystal layer components to pass therethrough. Specifically, the inorganic layer preferably has a density of 2.1 to 2.4 g/cm³. An inorganic layer having a low density tends to have low barrier performance. By contrast, an excessively high density leads to low flexibility, which increases the likelihood that peeling and cracks due to stress occur.

The density of the inorganic layer described in this specification is determined by X-ray reflectivity (XRR). The calculation of the density from XRR measurement results may be performed by a simulation using software. The XRR measurements can be performed, for example, using an ATX (manufactured by Rigaku Corporation). The simulation can be performed, for example, using GXRR analysis software (manufactured by Rigaku Corporation). The inorganic layer is assumed to be a monolayer.

The inorganic layer preferably contains, for example, a metal oxide, a metal nitride, a metal oxynitride, or a metal carbide. In particular, for example, an oxide, a nitride, a carbide, an oxynitride, or an oxynitride carbide containing at least one metal selected from the group consisting of Si, Al, In, Sn, Zn, Ti, Cu, Ce, Ta, Nb, Zr, and La is suitable for use. Of these, an oxide, a nitride, or an oxynitride of a metal selected from the group consisting of Si, Ti, Nb, Zr, and La is preferred. Specific examples include silicon oxide, tantalum oxide, zirconium oxide, titanium oxide, niobium oxide, and lanthanum titanate.

The inorganic layer may be formed by any method as long as the desired thin film can be formed. For example, physical vapor deposition (PVD) processes such as vapor deposition (e.g., ion-assisted deposition), sputtering, and ion plating; various chemical vapor deposition (CVD) processes; and liquid phase processes such as plating and sol-gel processes may be used. Plasma CVD is preferred.

The inorganic barrier layer preferably has a thickness of 1.0 nm or more and 1,000 nm or less, more preferably 3.0 nm or more and 500 nm or less, still more preferably 5.0 nm or more and 100 nm or less.

### Quarter-Wave Plate

The half mirror according to the present invention may include a quarter-wave plate. When the half mirror including a quarter-wave plate is used to form a mirror with an image display function having a configuration in which the quarter-wave plate is disposed between an image display device and a circularly polarized light reflecting layer, light from the image display device can be converted into circularly polarized light before entering the circularly polarized light reflecting layer. As a result, the amount of light that is reflected by the circularly polarized light reflecting layer and returns to the image display device side can be significantly reduced, thus enabling the display of bright images.

The quarter-wave plate may be a retardation layer that functions as a quarter-wave plate in the visible range. The quarter-wave plate may be, for example, a single-layer quarter-wave plate or a broadband quarter-wave plate formed of a laminate of a quarter-wave plate and a half-wave retardation plate.

The front retardation of the former quarter-wave plate may be a quarter of the emission wavelength of the image display device. Therefore, for example, when the emission wavelength of the image display device is 450 nm, 530 nm, and 640 nm, the quarter-wave plate is most preferably a retardation layer with reverse dispersion having a retardation of 112.5 nm±10 nm, preferably 112.5 nm±5 nm, more preferably 112.5 nm at a wavelength of 450 nm, a retardation of 132.5 nm±10 nm, preferably 132.5 nm±5 nm, more preferably 132.5 nm at a wavelength of 530 nm, and a retardation of 160 nm±10 nm, preferably 160 nm±5 nm, more preferably 160 nm at a wavelength of 640 nm. However, retardation plates having retardations with small wavelength dispersion and retardation plates with normal dispersion can also be used. Reverse dispersion means that the absolute value of retardation increases with increasing wavelength, and normal dispersion means that the absolute value of retardation increases with decreasing wavelength.

A laminate-type quarter-wave plate is used in such a manner that a quarter-wave plate and a half-wave retardation plate are stacked on top of each other with their slow axes making an angle of 60°, the half-wave retardation plate is disposed on the side on which linearly polarized light is incident, and the slow axis of the half-wave retardation plate makes an angle of 15° or 75° with a plane of polarization of incident linearly polarized light. The laminate-type quarter-wave plate is suitable for use for its good reverse dispersion of retardation.

Any quarter-wave plate may be appropriately selected according to the purpose. Examples include quartz plates, stretched polycarbonate films, stretched norbornene polymer films, aligned transparent films containing birefringent inorganic particles such as strontium carbonate, and thin films obtained by oblique vapor deposition of inorganic dielectrics on supports.

Examples of quarter-wave plates include (1) retardation plates including a birefringent film having a large retardation and a birefringent film having a small retardation that are stacked on top of each other such that their optical axes are orthogonal to each other, as described in JP1993-27118A (JP-H5-27118A) and JP1993-27119A (JP-H5-27119A), (2) a retardation plate in which a polymer film that acts as a quarter-wave plate at a specific wavelength and a polymer film that is made of the same material and acts as a half-wave plate at the specific wavelength are stacked on top of each other to thereby provide a quarter wavelength in a wide range of wavelengths, as described in JP1998-68816A (JP-H10-68816A), (3) a retardation plate in which two polymer films are stacked on top of each other to thereby achieve a quarter wavelength in a wide range of wavelengths, as described in JP1998-90521A (JP-H10-90521A), (4) a retardation plate that includes a modified polycarbonate film and achieves a quarter wavelength in a wide range of wavelengths, as described in WO00/26705A, and (5) a retardation plate that includes a cellulose acetate film and achieves a quarter wavelength in a wide range of wavelengths, as described in WO00/65384A.

The quarter-wave plate may be a commercially available product, and examples of commercially available products include PURE-ACE WR (trade name, manufactured by Teijin Limited).

The quarter-wave plate may be formed by aligning and fixing a polymerizable liquid crystal compound or a high-molecular liquid crystal compound. For example, the quarter-wave plate can be formed by applying a liquid crystal composition to a surface of a temporary support, an alignment film, or a front panel and then nematically aligning the polymerizable liquid crystal compound in the liquid crystalline state in the liquid crystal composition, followed by fixation by photocrosslinking or thermal crosslinking. Details of the liquid crystal composition and the production method will be described later. The quarter-wave plate may also be a layer obtained by applying a liquid crystal composition containing a high-molecular liquid crystal compound to a surface of a temporary support, an alignment film, or a front panel and nematically aligning the composition in the liquid crystalline state, followed by cooling to fix the alignment.

The quarter-wave plate and the circularly polarized light reflecting layer may be bonded to each other with a bonding layer or may be in direct contact with each other. The latter is preferred.

The quarter-wave plate and the circularly polarized light reflecting layer are preferably stacked on top of each other with their major surface areas being the same.

### Methods for Producing Cholesteric Liquid Crystal Layer and Quarter-Wave Plate Formed of Liquid Crystal Composition

Materials and methods for producing a cholesteric liquid crystal layer and a quarter-wave plate formed of a liquid crystal composition will now be described.

The material used to form the above-described quarter-wave plate may be, for example, a liquid crystal composition containing a polymerizable liquid crystal compound. The material used to form the cholesteric liquid crystal layer preferably further includes a chiral agent (optically active compound). The quarter-wave plate or the cholesteric liquid crystal layer can be formed by applying the liquid crystal composition, which may optionally be mixed with a surfactant, a polymerization initiator, or the like and dissolved in a solvent or the like, to a support, a temporary support, an alignment film, a quarter-wave plate, or a cholesteric liquid crystal layer to serve as an underlayer and performing maturing of alignment, followed by fixation by curing of the liquid crystal composition.

### Polymerizable Liquid Crystal Compound

The polymerizable liquid crystal compound may be a rod-like liquid crystal compound.

Examples of rod-like polymerizable liquid crystal compounds include rod-like nematic liquid crystal compounds. Examples of rod-like nematic liquid crystal compounds that are suitable for use include azomethines, azoxies, cyanobiphenyls, cyanophenyl esters, benzoic acid esters, cyclohexanecarboxylic acid phenyl esters, cyanophenyl cyclohexanes, cyano-substituted phenylpyrimidines, alkoxy-substituted phenylpyrimidines, phenyldioxanes, tolans, and alkenyl cyclohexyl benzonitriles. High-molecular liquid crystal compounds as well as low-molecular liquid crystal compounds can be used.

The polymerizable liquid crystal compound is obtained by introducing a polymerizable group into a liquid crystal compound. Examples of polymerizable groups include unsaturated polymerizable groups, an epoxy group, and an aziridinyl group. Unsaturated polymerizable groups are preferred, and ethylenically unsaturated polymerizable groups are particularly preferred. The polymerizable group can be introduced into the molecules of a liquid crystal compound by various methods. The number of polymerizable groups in the polymerizable liquid crystal compound is preferably 1 to 6, more preferably 1 to 3. Examples of polymerizable liquid crystal compounds include compounds described in Makromol. Chem., vol. 190, p. 2255 (1989), Advanced Materials, vol. 5, p. 107 (1993), U.S. Pat. No. 4,683,327A, U.S. Pat. No. 5,622,648A, U.S. Pat. No. 5,770,107A, WO95/22586A, WO95/24455A, WO97/00600A, WO98/23580A, WO98/52905A, JP1989-272551A (JP-H1-272551A), JP1994-16616A (JP-H6-16616A), JP1995-110469A (JP-H7-110469A), JP1999-80081A (JP-H11-80081A), and JP2001-328973A. Two or more polymerizable liquid crystal compounds may be used in combination. The combined use of two or more polymerizable liquid crystal compounds enables alignment at lower temperatures.

The amount of polymerizable liquid crystal compound in the liquid crystal composition is preferably 80% to 99.9% by mass, more preferably 85% to 99.5% by mass, particularly preferably 90% to 99% by mass, relative to the mass of solids (the mass excluding the mass of solvent) in the liquid crystal composition.

### Chiral Agent: Optically Active Compound

The liquid crystal composition used to form a cholesteric liquid crystal layer preferably contains a chiral agent. The chiral agent has a function of inducing a helical structure of the cholesteric liquid crystalline phase. The chiral compound may be selected according to the purpose since the helical sense or helical pitch to be induced varies depending on the compound.

The chiral agent for use may be any known compound. Examples of chiral agents include compounds described in Liquid Crystal Device Handbook (chapter 3, section 4-3, Chiral Agent for TN and STN, page 199, edited by 142nd Committee of Japan Society for the Promotion of Science, 1989), JP2003-287623A, JP2002-302487A, JP2002-80478A, JP2002-80851A, JP2010-181852A, and JP2014-034581A.

Although chiral agents generally contain asymmetric carbon atoms, axial asymmetric compounds and planar asymmetric compounds, which contain no asymmetric carbon atoms, can also be used as chiral agents. Examples of axial asymmetric compounds and planar asymmetric compounds include binaphthyls, helicenes, paracyclophanes, and derivatives thereof. The chiral agent may have a polymerizable group. When the chiral agent and the liquid crystal compound both have a polymerizable group, a polymer having a repeating unit derived from the polymerizable liquid crystal compound and a repeating unit derived from the chiral agent can be formed by the polymerization reaction of the polymerizable chiral agent with the polymerizable liquid crystal compound. In this case, the polymerizable group of the polymerizable chiral agent is preferably the same group as the polymerizable group of the polymerizable liquid crystal compound. Therefore, the polymerizable group of the chiral agent is also preferably an unsaturated polymerizable group, an epoxy group, or an aziridinyl group, more preferably an unsaturated polymerizable group, particularly preferably an ethylenically unsaturated polymerizable group.

The chiral agent may be a liquid crystal compound.

The chiral agent is preferably an isosorbide derivative, an isomannide derivative, or a binaphthyl derivative. The isosorbide derivative may be a commercially available product such as LC-756 manufactured by BASF.

The chiral agent content of the liquid crystal composition is preferably 0.01 mol % to 200 mol %, more preferably 1.0 mol % to 30 mol %, relative to the total molar quantity of the polymerizable liquid crystal compound.

### Polymerization Initiator

The liquid crystal composition preferably contains a polymerization initiator. In the case where polymerization reaction is driven by ultraviolet irradiation, the polymerization initiator for use is preferably a photopolymerization initiator capable of initiating polymerization reaction in response to ultraviolet irradiation, particularly preferably a radical photopolymerization initiator. Examples of radical photopolymerization initiators include α-carbonyl compounds (described in U.S. Pat. No. 2,367,661A and U.S. Pat. No. 2,367,670A, acyloin ethers (described in U.S. Pat. No. 2,448,828A), a-hydrocarbon-substituted aromatic acyloin compounds (described in U.S. Pat. No. 2,722,512A), polynuclear quinone compounds (described in U.S. Pat. No. 3,046,127A and U.S. Pat. No. 2,951,758A), combinations of triarylimidazole dimers and p-aminophenyl ketone (described in U.S. Pat. No. 3,549,367A), acridine and phenazine compounds (described in JP1985-105667A (JP-S60-105667A) and U.S. Pat. No. 4,239,850A), acylphosphine oxide compounds (described in JP1988-40799B (JP-S63-40799B), JP1993-29234B (JP-H5-29234B), JP1998-95788A (JP-H10-95788A), and JP1998-29997A (JP-H10-29997A)), oxime compounds (described in JP1988-40799B (JP-S63-40799B), JP1993-29234B (JP-H5-29234B), JP1998-95788A (JP-H10-95788A), JP1998-29997A (JP-H10-29997A), JP2001-233842A, JP2000-80068A, JP2006-342166A, JP2013-114249A, JP2014-137466A, JP4223071B, JP2010-262028A, and JP2014-500852A), and oxadiazole compounds (described in U.S. Pat. No. 4,212,970A). For example, reference can also be made to the description in paragraphs 0500 to 0547 of JP2012-208494A.

The polymerization initiator is also preferably an acylphosphine oxide compound or an oxime compound.

Examples of acylphosphine oxide compounds that can be used include IRGACURE 819 (compound name: bis(2,4,6-trimethylbenzoyl)-phenylphosphine oxide) manufactured by BASF Japan. Examples of oxime compounds that can be used include commercially available products such as IRGACURE OXE01 (manufactured by BASF), IRGACURE OXE02 (manufactured by BASF), TR-PBG-304 (manufactured by Changzhou Tronly New Electronic Materials Co., Ltd.), ADEKA ARKLS NCI-831, ADEKA ARKLS NCI-930 (manufactured by ADEKA Corporation), and ADEKA ARKLS NCI-831 (manufactured by ADEKA Corporation).

These polymerization initiators may be used alone or in combination.

The amount of polymerization initiator in the liquid crystal composition is preferably 0.1% to 20% by mass, more preferably 0.5% by mass to 5.0% by mass, relative to the amount of polymerizable liquid crystal compound.

### Crosslinking Agent

The liquid crystal composition may optionally contain a crosslinking agent in order to provide improved film hardness and improved durability after curing. Crosslinking agents that are curable by ultraviolet light, heat, moisture, and the like are suitable for use.

Any crosslinking agent may be appropriately selected according to the purpose. Examples include polyfunctional acrylate compounds such as trimethylolpropane tri(meth)acrylate and pentaerythritol tri(meth)acrylate; epoxy compounds such as glycidyl (meth)acrylate and ethylene glycol diglycidyl ether; aziridine compounds such as 2,2-bishydroxymethylbutanol-tris[3 -(1-aziridinyl)propionate] and 4,4-bis(ethyleneiminocarbonylamino)diphenylmethane; isocyanate compounds such as hexamethylene diisocyanate and biuret-type isocyanate; polyoxazoline compounds having oxazoline side groups; and alkoxysilane compounds such as vinyltrimethoxysilane and N-(2-aminoethyl)3-aminopropyltrimethoxysilane. In addition, a known catalyst can be used according to the reactivity of the crosslinking agent. The use of a known catalyst can improve the productivity in addition to the film hardness and the durability. These crosslinking agents may be used alone or in combination.

The amount of crosslinking agent in the liquid crystal composition is preferably 3.0% to 20% by mass, more preferably 5.0% to 15% by mass. A crosslinking agent in an amount of 3.0% by mass or more can produce the effect of improving the crosslink density. A crosslinking agent in an amount of 20% by mass or less can maintain the stability of layers formed.

### Alignment Controlling Agent

An alignment controlling agent that contributes to stably or rapidly achieving planar alignment may be added to the liquid crystal composition. Examples of alignment controlling agents include fluorine (meth)acrylate polymers described in paragraphs 0018 to 0043 of JP2007-272185A and compounds represented by formulae (I) to (IV) described in paragraphs 0031 to 0034 of JP2012-203237A.

These alignment controlling agents may be used alone or in combination.

The amount of alignment controlling agent in the liquid crystal composition is preferably 0.01% to 10% by mass, more preferably 0.01% to 5.0% by mass, particularly preferably 0.02% to 1.0% by mass, relative to the total mass of the polymerizable liquid crystal compound.

### Other Additives

In addition, the liquid crystal composition may contain at least one selected from the group consisting of various additives such as polymerizable monomers and surfactants for adjusting the surface tension of a coating to make the coating thickness uniform. Optionally, the liquid crystal composition may further contain, for example, a polymerization inhibitor, an antioxidant, an ultraviolet absorber, a light stabilizer, a coloring material, and fine metal oxide particles to the extent that the optical performance is not degraded.

### Solvent

For the preparation of the liquid crystal composition, any solvent appropriately selected according to the purpose may be used. Organic solvents are suitable for use.

Any organic solvent may be appropriately selected according to the purpose. Examples include ketones, alkyl halides, amides, sulfoxides, heterocyclic compounds, hydrocarbons, esters, and ethers. These may be used alone or in combination. Of these, ketones are particularly preferred in view of environmental load.

### Application, Alignment, and Polymerization

For the application of the liquid crystal composition to a temporary support, an alignment film, a quarter-wave plate, a cholesteric liquid crystal layer to serve as an underlayer, or the like, any method may be appropriately selected according to the purpose. Examples include wire bar coating, curtain coating, extrusion coating, direct gravure coating, reverse gravure coating, die coating, spin coating, dip coating, spray coating, and slide coating. Alternatively, the application can also be performed by transferring the liquid crystal composition applied to another support. The liquid crystal composition applied is heated to align liquid crystal molecules. When a cholesteric liquid crystal layer is formed, the molecules are cholesterically aligned. When a quarter-wave plate is formed, the molecules are preferably nematically aligned. The heating temperature for cholesteric alignment is preferably 200° C. or lower, more preferably 130° C. or lower. This alignment treatment provides an optical thin film in which the polymerizable liquid crystal compound is twistedly aligned so as to have a helical axis in a direction substantially perpendicular to the film plane. The heating temperature for nematic alignment is preferably 50° C. to 120° C., more preferably 60° C. to 100° C.

The aligned liquid crystal compound can be further polymerized to be cured. The polymerization may be thermal polymerization or photopolymerization using light irradiation and is preferably photopolymerization. For the light irradiation, ultraviolet rays are preferably used. The irradiation energy is preferably 20 mJ/cm² to 50 J/cm², more preferably 100 mJ/cm² to 1,500 mJ/cm². To promote the photopolymerization, the light irradiation may be performed under heating conditions or in a nitrogen atmosphere. The wavelength of ultraviolet radiation is preferably 350 nm to 430 nm. From the viewpoint of stability, the rate of polymerization reaction is preferably high, specifically, 70% or more, more preferably 80% or more. The rate of polymerization reaction can be determined by measuring the consumption rate of polymerizable groups by using an IR absorption spectrum.

Each cholesteric liquid crystal layer may have any thickness as long as the properties described above are exhibited, but the thickness is preferably 1.0 μm or more and 150 μm or less, more preferably 4.0 μm or more and 100 μm or less. The quarter-wave plate formed of the liquid crystal composition may have any thickness, but the thickness is preferably 0.2 μm to 10 μm, more preferably 0.5 μm to 2.0 μm.

### Temporary Support and Support

The liquid crystal composition may be formed as a layer by being applied to a surface of a support, a temporary support, or an alignment layer formed on a surface of the support or the temporary support.

The temporary support or the temporary support and alignment layer may be peeled off after the layer formation. For example, they may be peeled off after a circularly polarized light reflecting layer is bonded to a front panel. The temporary support may function as a protective film from when the circularly polarized light reflecting layer is bonded to the front panel until the circularly polarized light reflecting layer is further bonded to an image display device.

The support may remain as a layer constituting the half mirror without being peeled off. In the half mirror, the front panel, the circularly polarized light reflecting layer, and the support may be disposed in this order (e.g., FIGS. 1E and 1G). Alternatively, the support may constitute a part of the front panel (e.g., FIG. 1F).

The temporary support and the support may be, for example, a plastic film or a glass plate. Examples of materials of the plastic film include polyesters such as polyethylene terephthalate (PET), polycarbonates, acrylic resins, epoxy resins, polyurethanes, polyamides, polyolefins, cellulose derivatives such as triacetylcellulose, and silicones. The temporary support is preferably a polyethylene terephthalate (PET) film, and the support is preferably a triacetyl cellulose film.

### Alignment Layer

The alignment layer can be provided by means of, for example, rubbing treatment of an organic compound such as a polymer (resin such as polyimide, polyvinyl alcohol, polyester, polyarylate, polyamide-imide, polyetherimide, polyamide, or modified polyamide), oblique deposition of an inorganic compound, formation of a layer having microgrooves, or accumulation of an organic compound (e.g., ω-tricosanoic acid, dioctadecylmethylammonium chloride, or methyl stearate) by the Langmuir-Blodgett method (LB film). Furthermore, an alignment layer whose alignment function is activated by application of an electric field, application of a magnetic field, or light irradiation may be used.

In particular, preferably, an alignment layer made of a polymer is subjected to rubbing treatment, and then the liquid crystal composition is applied to the rubbing-treated surface. The rubbing treatment can be performed by rubbing a surface of the polymer layer with paper or cloth in a certain direction several times.

The liquid crystal composition may be applied to a surface of the temporary support or a rubbing-treated surface of the temporary support without providing an alignment layer.

The alignment layer preferably has a thickness of 0.01 μm to 5.0 μm, more preferably 0.05 μm to 2.0 μm.

### Laminated Film of Layers Formed of Polymerizable Liquid Crystal Compound

To form a laminated film constituted by a plurality of cholesteric liquid crystal layers or a laminated film constituted by a quarter-wave plate and a plurality of cholesteric liquid crystal layers, the step of applying a liquid crystal composition containing a polymerizable liquid crystal compound and other components directly to a surface of the quarter-wave plate or the previous cholesteric liquid crystal layer, the alignment step, and the fixation step may be repeated. Alternatively, a quarter-wave plate separately provided and cholesteric liquid crystal layers or a laminate thereof may be laminated together using, for example, an adhesive. The former method is preferred. One reason is that interference fringes due to the unevenness in the thickness of a bonding layer is less likely to be observed. Another reason is that since the laminated film of cholesteric liquid crystal layers is formed such that the next cholesteric liquid crystal layer is formed so as to be in direct contact with a surface of the previously formed cholesteric liquid crystal layer, the alignment azimuth of liquid crystal molecules on the air interface side of the previously formed cholesteric liquid crystal layer agrees with the alignment azimuth of liquid crystal molecules on the lower side of the cholesteric liquid crystal layer formed thereon, and the laminate of cholesteric liquid crystal layers has good polarization properties.

### Method for Fabricating Half Mirror

The half mirror may be fabricated by transferring, to a front panel, a circularly polarized light reflecting layer formed on a temporary support or a quarter-wave plate and circularly polarized light reflecting layer formed on a temporary support. For example, a cholesteric liquid crystal layer or a laminate of cholesteric liquid crystal layers is formed on a temporary support to obtain a circularly polarized light reflecting layer. The surface of the circularly polarized light reflecting layer is then bonded to a front panel with a bonding layer interposed therebetween. Thereafter, the temporary support is optionally peeled off, and a quarter-wave plate is further provided to obtain a half mirror. Alternatively, a quarter-wave plate and a cholesteric liquid crystal layer are sequentially formed on a temporary support to obtain a laminate of the quarter-wave plate and the circularly polarized light reflecting layer. The surface of the cholesteric liquid crystal (circularly polarized light reflecting layer) is then bonded to a front panel with a bonding layer interposed therebetween. Thereafter, the temporary support is optionally peeled off to obtain a half mirror.

Alternatively, the half mirror can be fabricated by bonding, to a front panel, a circularly polarized light reflecting layer formed on a support or a quarter-wave plate and circularly polarized light reflecting layer formed on a support. Alternatively, the half mirror can be fabricated by using, as a front panel, a support on which a circularly polarized light reflecting layer is formed or a support on which a circularly polarized light reflecting layer and a quarter-wave plate are formed. The quarter-wave plate may be separately provided and bonded.

Mirror with Image Display Function

The above half mirror can be used to fabricate a mirror with an image display function. The mirror with an image display function includes the above half mirror and an image display device. In the mirror with an image display function, the image display device, the circularly polarized light reflecting layer, and the front panel are disposed in this order. In the mirror with an image display function, the image display device and the half mirror may be in direct contact with each other, may be interposed by an air layer, or may be directly bonded to each other with a bonding layer interposed therebetween.

In the mirror with an image display function, a half mirror having a major surface with an area equal to that of an image display unit of the image display device may be used, or a half mirror having a major surface with an area larger or smaller than that of the image display unit of the image display device may be used. By the choice of such a relation, the proportion and position of the image display unit surface relative to the entire surface of the mirror can be adjusted.

When a half mirror including a quarter-wave plate is used, the slow axis of the quarter-wave plate in the mirror with an image display function is preferably adjusted so that images are most brightly displayed. Specifically, with respect particularly to an image display device that displays images using linearly polarized light, the relation between the polarization direction (transmission axis) of the linearly polarized light and the slow axis of the quarter-wave plate is preferably adjusted so that the linearly polarized light can be best transmitted. For example, in the quarter-wave plate, the transmission axis and the slow axis preferably form an angle of 45°. Light emitted from the image display device that displays images using linearly polarized light becomes circularly polarized light of either a right-handed or left-handed sense after passing through the quarter-wave plate. The circularly polarized light reflecting layer described later may be constituted by a cholesteric liquid crystal layer having a twisted direction that allows circularly polarized light of the above sense to pass.

Interposing the quarter-wave plate between the image display device and the circularly polarized light reflecting layer allows light from the image display device to convert into circularly polarized light before entering the circularly polarized light reflecting layer. As a result, the amount of light that is reflected by the circularly polarized light reflecting layer and returns to the image display device side can be significantly reduced, thus enabling the display of bright images.

### Image Display Device

Any image display device may be used. The image display device is preferably an image display device that emits (gives off) linearly polarized light to form an image. More preferably, the image display device is a liquid crystal display device or an organic EL device.

The liquid crystal display device may be of a transmissive type or a reflective type and is particularly preferably of a transmissive type. The liquid crystal display device may be any liquid crystal display device such as an in-plane switching (IPS) mode device, a fringe field switching (FFS) mode device, a vertical alignment (VA) mode device, an electrically controlled birefringence (ECB) mode device, a super twisted nematic (STN) mode device, a twisted nematic (TN) mode device, or an optically compensated bend (OCB) mode device.

Images displayed on the image display unit of the image display device may be still images, motion pictures, or simple textual information. The images may be displayed as mono-color images, such as black and white images, multi-color images, or full-color images. Preferred examples of such images displayed on the image display unit of the image display device include images picked up by onboard cameras. These images are preferably motion pictures.

The image display device, for example, may show a red light emission peak wavelength λR, a green light emission peak wavelength λG, and a blue light emission peak wavelength λB in an emission spectrum at the time of white display. Having such emission peak wavelengths enables a full-color image display. λR may be any wavelength in the range of 580 nm to 700 nm, preferably in the range of 610 nm to 680 nm. λG may be any wavelength in the range of 500 nm to 580 nm, preferably in the range of 510 nm to 550 nm. λB may be any wavelength in the range of 400 nm to 500 nm, preferably in the range of 440 nm to 480 nm.

### Other Bonding Layers

The half mirror or the mirror with an image display function according to the present invention may include other bonding layers for bonding the image display device and the circularly polarized light reflecting layer together or for bonding various other layers together. The other bonding layer may be formed of an adhesive.

The other bonding layer may be the same as the above-described bonding layer for bonding the circularly polarized light reflecting layer and the front panel together. Typically, the other bonding layer is preferably a bonding layer formed of a sheet-shaped adhesive.

Method for Fabricating Mirror with Image Display Function

The mirror with an image display function can be fabricated by disposing the above half mirror on the image display side of an image display device and integrating the image display device with the half mirror. In the half mirror, the image display device, the circularly polarized light reflecting layer, and the front panel are disposed in this order. The integration of the image display device with the half mirror may be performed by interconnection with a frame or hinge or by bonding. For example, the mirror with an image display function according to the present invention can be fabricated by bonding the half mirror to the image display surface of the image display device. The bonding is performed such that the front panel, the circularly polarized light reflecting layer, and the image display device are disposed in this order.

Half Mirror with Polarizer

The half mirror according to the present invention may be provided in the form of a half mirror with a polarizer. The half mirror with a polarizer may be used to produce a mirror with an image display function. That is, in an image display device that has a polarizing plate on the image display side and emits linearly polarized light to form an image, the polarizing plate may be replaced with a half mirror with a polarizer to produce a mirror with an image display function.

In the half mirror with a polarizer, the polarizer, the circularly polarized light reflecting layer, and the front panel may be disposed in this order. The polarizer may be, for example, bonded to the circularly polarized light reflecting layer or the quarter-wave plate.

### Polarizer

Examples of polarizers include iodine-containing polarizers, dye-containing polarizers including dichroic dyes, and polyene-containing polarizers. Iodine-containing polarizers and dye-containing polarizers are typically produced by using polyvinyl alcohol films. For example, polarizers may be constituted by a modified or unmodified polyvinyl alcohol and dichroic molecules. Regarding such a polarizer constituted by a modified or unmodified polyvinyl alcohol and dichroic molecules, refer to the description of JP2009-237376A, for example. The polarizer may have a thickness of 50 μm or less, preferably 30 μm or less, more preferably 20 μm or less. Typically, the thickness of the polarizer may be 1.0 μm or more, 5.0 μm or more, or 10 μm or more.

Preferably, the polarizer has a polarizer-protective layer on one or both main surfaces. When the polarizer has a polarizer-protective layer on one main surface, the main surface may be a surface to be bonded to the circularly polarized light reflecting layer or the quarter-wave plate or the opposite surface, preferably the opposite surface.

The polarizer-protective layer may be a cellulose acylate polymer film, an acrylic polymer film, or a cycloolefin polymer film. Regarding cellulose acylate polymers, refer to the description on cellulose acylate resins of JP2011-237474A. Regarding cycloolefin polymer films, refer to the descriptions of JP2009-175222A and JP2009-237376A.

The polarizer-protective layer may contain one or two or more of the above polymers as the principal components in an amount of, for example, 70% by mass or more, 80% by mass or more, 90% by mass or more, 95% by mass or more, 99% by mass or more, or 100% by mass.

The polarizer-protective layer may have a thickness of 100 μm or less, 50 μm or less, 30 μm or less, 20 μm or less, or 10 μm or less and 1.0 μm or more, 5.0 μm or more, or 10 μM or more.

The polarizer-protective layer may be provided, for example, by applying a composition for protective layer formation directly to the surface to be provided with the protective layer and drying the composition or may be bonded with a bonding layer.

Applications of Mirror with Image Display Function

The mirror with an image display function may be used in any application. For example, the mirror can be used as a security mirror, a mirror in a beauty parlor or barbershop, or the like to display images such as textual information, still images, and motion pictures. The mirror with an image display function according to the present invention may be a vehicle rear-view mirror or may be used for television sets, personal computers, smartphones, and cellular phones.

Particularly preferably, the mirror with an image display function is used as a vehicle rear-view mirror. For use as a rear-view mirror, the mirror with an image display function may have a support arm or the like for attachment to a frame, a housing, or a vehicle main body. Alternatively, the vehicle mirror with an image display function may be formed for incorporation into a rear-view mirror. The vehicle mirror with an image display function having such a shape is generally able to determine the upward, downward, right, and left directions during use.

If the mirror with an image display function is curved such that the convex surface is on the front side, the mirror can be used as a wide-angle mirror that allows rearward views and the like to be visible at wide angles. Such a curved front can be fabricated using a curved half mirror.

The curve may be in the vertical direction, the horizontal direction, or both the vertical and horizontal directions. The radius of curvature of the curve is preferably 500 mm to 3,000 mm, more preferably 1,000 mm to 2,500 mm. The radius of curvature is a radius of an imaginary circumcircle of the curved portion in section.

### EXAMPLES

The present invention will now be described in more detail with reference to examples. Materials, reagents, amounts and percentages of substances, operations, etc. used in the following examples can be changed as appropriate without departing from the spirit of the present invention. Therefore, it should be noted that the following examples are not intended to limit the scope of the present invention.

### Fabrication of Half Mirror

### Preparation of Coating Solution

### Coating Solution for Cholesteric Liquid Crystal Layer Formation

The following components were mixed together to prepare a coating solution for cholesteric liquid crystal layer formation having the following composition.

| | |
|---|---|
| Compound 1 | 80 parts by mass |
| Compound 2 | 20 parts by mass |
| Fluorine-based horizontal alignment | 0.1 parts by mass |
| agent 1 | |
| Fluorine-based horizontal alignment | 0.007 parts by mass |
| agent 2 | |
| Right-handed chiral agent LC756 | adjusted according to the |
| (manufactured by BASF) | desired reflection wavelength |
| Polymerization initiator IRGACURE | 3.0 parts by mass |
| OXE01 (manufactured by BASF) | |
| Solvent (methyl ethyl ketone) | an amount to provide a solute |
| | concentration of 30% by mass |

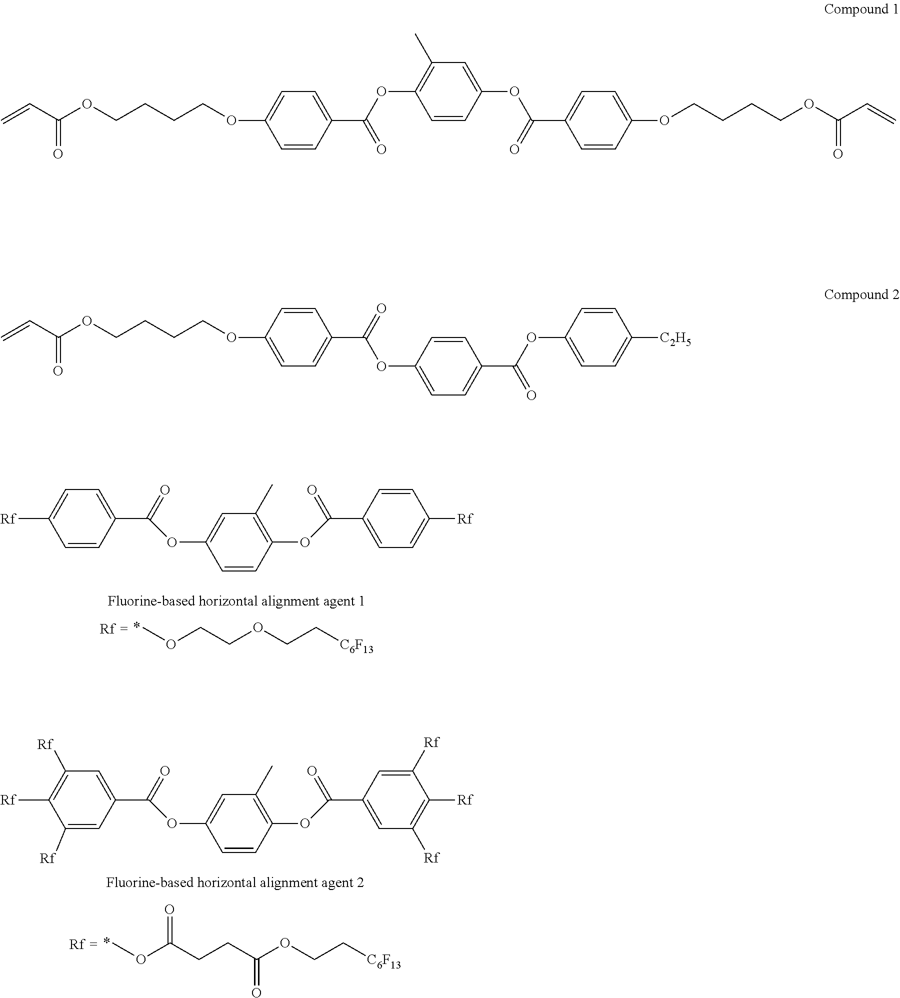

The amount of the chiral agent LC-756 in the above composition for coating solution was varied to prepare coating solutions 1 to 3. Using each coating solution, a monolayered cholesteric liquid crystal layer was formed on a temporary support as in the fabrication of a circularly polarized light reflecting layer described below, and the reflection properties were evaluated. The cholesteric liquid crystal layers formed were all right-handed circularly polarized light reflecting layers and had central reflection wavelengths as shown in Table 1.

TABLE 1

| Coating solution | Central reflection wavelength |
|---|---|
| Coating solution 1 | 630 nm |
| Coating solution 2 | 540 nm |
| Coating solution 3 | 450 nm |

Coating Solution for Quarter-Wave Plate Formation

The following components were mixed together to prepare a coating solution for quarter-wave plate formation having the following composition.

| | |
|---|---|
| Compound 1 | 80 parts by mass |
| Compound 2 | 20 parts by mass |
| Fluorine-based horizontal alignment agent 1 | 0.1 parts by mass |
| Fluorine-based horizontal alignment agent 2 | 0.007 parts by mass |
| Polymerization initiator IRGACURE OXE01 | 3.0 parts by mass |
| (manufactured by BASF) | |
| Solvent (methyl ethyl ketone) | an amount to provide |
| | a solute concentration |
| | of 30% by mass |

### Coating Solution for Barrier Layer Formation

Coating solutions having the following compositions were prepared. The Tg of the coating solutions was determined by DSC according to the above procedure.

(a) Coating Solution for Barrier Layer Formation Containing Acrylate Monomer (Examples 1 to 3 and Examples 11 to 19) (here, the term “acrylate monomer” is intended to include urethane (meth)acrylate monomers and (meth)acrylate monomers)

| | |
|---|---|
| Acrylate monomer shown in Table 2 | 100 parts by mass |
| Polymeric surfactant B1176 (manufactured by | 0.05 parts by mass |
| DIC Corporation) | |
| Polymerization initiator IRGACURE OXE01 | 1.0 part by mass |
| (manufactured by BASF) | |
| Solvent (methyl ethyl ketone) | an amount to provide |
| | a solute concentration |
| | of 40% by mass |

(b) Coating Solution for Barrier Layer Formation Containing Urethane Polymer (Example 4)

| | |
|---|---|
| Urethane (meth)acrylate monomer U-6LPA | 75 parts by mass |
| (manufactured by Shin-Nakamura Chemical | |
| Co., Ltd.) | |
| Urethane polymer 8BR-600 (manufactured | 25 parts by mass |
| by Taisei Fine Chemical Co., Ltd.) | |
| Polymeric surfactant B1176 (manufactured | 0.05 parts by mass |
| by DIC Corporation) | |
| Polymerization initiator IRGACURE OXE01 | 1.0 part by mass |
| (manufactured by BASF) | |
| Solvent (methyl ethyl ketone) | an amount to provide |
| | a solute concentration |
| | of 40% by mass |

(c) Coating Solution for Barrier Layer Formation Containing Plurality of Acrylate Monomers (Example 5)

| | |
|---|---|
| Urethane (meth)acrylate monomer U-6LPA | 50 parts by mass |
| (manufactured by Shin-Nakamura Chemical | |
| Co., Ltd.) | |
| Urethane acrylate resin UA122P (manufactured | 50 parts by mass |
| by Shin-Nakamura Chemical Co., Ltd.) | |
| Polymeric surfactant B1176 (manufactured by | 0.05 parts by mass |
| DIC Corporation) | |
| Polymerization initiator IRGACURE OXE01 | 1.0 part by mass |
| (manufactured by BASF) | |
| Solvent (methyl ethyl ketone) | an amount to provide |
| | a solute concentration |
| | of 40% by mass |

(d) Coating Solution for Barrier Layer Formation Containing Epoxy Monomer (Examples 6 to 10)

| | |
|---|---|
| Epoxy monomer shown in Table 2 | 100 parts by mass |
| Polymeric surfactant B1176 (manufactured | 0.05 parts by mass |
| by DIC Corporation) | |
| Polymerization initiator PAG-1 | 1.0 part by mass |
| Solvent (mixture of methyl ethyl ketone | an amount to provide |
| with methyl isobutyl ketone at 3:7) | a solute concentration |
| | of 40% by mass |

The monomers shown in Table 2 are as follows.

U6LPA: urethane (meth)acrylate monomer U-6LPA (manufactured by Shin-Nakamura Chemical Co., Ltd.)
U4HA: urethane (meth)acrylate monomer U-4HA (manufactured by Shin-Nakamura Chemical Co., Ltd.)
EBECRYL 220: aromatic urethane acrylate EBECRYL 220 (manufactured by DAICEL-ALLNEX LTD.)
8BR-600: urethane polymer 8BR-600 (manufactured by Taisei Fine Chemical Co., Ltd.)
UA122P: urethane acrylate resin UA122P (manufactured by Shin-Nakamura Chemical Co., Ltd.)
CEL2021P: bifunctional alicyclic epoxy resin CELLOXIDE 2021P (manufactured by Daicel Corporation)
CEL8000: alicyclic epoxy resin CELLOXIDE 8000 (manufactured by Daicel Corporation)
CYCLOMER M100: methacrylate monomer CYCLOMER M-100 (manufactured by Daicel Corporation)
EPICLON: bifunctional naphthalene-type epoxy resin EPICLON HP-4032D (manufactured by DIC Corporation)
HP-4032D: (manufactured by DIC Corporation)
ADCP: bifunctional acrylate A-DCP (manufactured by Shin-Nakamura Chemical Co., Ltd.)
DPHA: acrylate monomer DPHA (manufactured by Shin-Nakamura Chemical Co., Ltd.)
SP-327: manufactured by Osaka Organic Chemical Industry Ltd.
PET30: pentaerythritol (tri/tetra)acrylate KAYARAD PET-30 (manufactured by Nippon Kayaku Co., Ltd.)
DPCA20: caprolactone-modified dipentaerythritol hexaacrylate DPCA20 (manufactured by Nippon Kayaku Co., Ltd.)
DPCA120: caprolactone-modified dipentaerythritol hexaacrylate DPCA120 (manufactured by Nippon Kayaku Co., Ltd.)

### Fabrication of Half Mirrors of Examples 1 to 16 and Comparative Example 1

(1) A Toyobo PET film (Cosmoshine A4100, 100 μm thick) was used as a temporary support (150 mm×100 mm). One surface thereof was subjected to rubbing treatment (rayon cloth; pressure, 0.1 kgf (0.98 N); the number of revolutions, 1,000 rpm; transport speed, 10 m/min; the number of reciprocating cycles, 1).

(2) The coating solution for quarter-wave plate formation was applied to the rubbing-treated surface of the PET film using a wire bar and then dried. The coated PET film was then placed on a hot plate at 30° C. and irradiated with UV light for 6 seconds using a D-Bulb electrodeless lamp (60 mW/cm²) manufactured by Fusion UV Systems, Inc. to fix the liquid crystalline phase, thereby obtaining a retardation layer (quarter-wave plate) having a thickness of 0.8 μm. Coating solution 1 was applied to the surface of the retardation layer using a wire bar and then dried. The coated retardation layer was then placed on a hot plate at 30° C. and irradiated with UV light for 6 seconds using a D-Bulb electrodeless lamp (60 mW/cm²) manufactured by Fusion UV Systems, Inc. to fix the cholesteric liquid crystalline phase, thereby obtaining a cholesteric liquid crystal layer having a thickness of 3.5 μm. Coating solution 2 and Coating solution 3 were further applied in this order to the surface of the cholesteric liquid crystal layer, and the same procedure was repeated (layer of Coating solution 2, 3.0 μm; layer of Coating solution 3, 2.7 μm). In this manner, Laminate A constituted by the quarter-wave plate and a circularly polarized light reflecting layer (three cholesteric liquid crystal layers) was obtained. The transmission spectrum of Laminate A was measured with a spectrophotometer (V-670, manufactured by JASCO Corporation) and found to have selective reflection center wavelengths at 630 nm, 540 nm, and 450 nm.

(3) Regarding half mirrors having a barrier layer, each coating solution for barrier layer formation was further applied to a surface of Laminate A on the cholesteric liquid crystal layer side at room temperature using a wire bar such that the dry thickness would be 3.0 μm. The coating layer was dried at room temperature for 10 seconds, heated in an atmosphere at 85° C. for 1 minute, and then irradiated with UV light at 70° C. for 5 seconds using a Fusion D-Bulb (lamp, 90 mW/cm²) at an output of 80%.

(4) Using a laminator, OCA tape (MHM-FWD25 manufactured by Nichiei Kakoh Co., Ltd., 25 μm thick) was laminated to a 50 mm square glass plate, and then the protective film of the OCA tape was peeled off. Next, using the laminator, the glass plate with the adhesive layer of OCA was laminated to a surface of Laminate A on the circularly polarized light reflecting layer side or a surface of Laminate A with a barrier layer on the barrier layer side. The temporary support (PET) was then peeled off to fabricate a 50 mm square half mirror.

### Fabrication of Half Mirror of Example 17

A half mirror of Example 17 was fabricated in the same manner as the half mirror of Example 1 except that the above rubbed temporary support was replaced with a support with an alignment layer prepared according to the following procedure and that the alignment layer and the support were not peeled off.

A FUJIFILM triacetyl cellulose film (FUJITAC, 80 μm thick) was used as a support (150 mm×100 mm). A predetermined amount of 2% by mass solution of long-chain-alkyl-modified poval (MP-203, manufactured by Kuraray Co., Ltd.) was applied to the support and then dried to form an alignment resin layer. One surface thereof was subjected to rubbing treatment (rayon cloth; pressure, 0.5 kgf (4.9 N); the number of revolutions, 1,000 rpm; transport speed, 10 m/min; the number of reciprocating cycles, 1) to obtain a support with an alignment layer.

### Fabrication of Half Mirror of Example 18

(1) Triacetyl cellulose (FUJITAC, manufactured by FUJIFILM Corporation) was used as a support (150 mm×100 mm). A predetermined amount of 2% by mass solution of long-chain-alkyl-modified poval (MP-203, manufactured by Kuraray Co., Ltd.) was applied to the support and then dried to form an alignment resin layer. One surface thereof was subjected to rubbing treatment (rayon cloth; pressure, 0.5 kgf (4.9 N); the number of revolutions, 1,000 rpm; transport speed, 10 m/min; the number of reciprocating cycles, 1).

Coating solution 1 was applied to the rubbing-treated surface using a wire bar and then dried. The resultant was then placed on a hot plate at 30° C. and irradiated with UV light for 6 seconds using a D-Bulb electrodeless lamp (60 mW/cm²) manufactured by Fusion UV Systems, Inc. to fix the cholesteric liquid crystalline phase, thereby obtaining a cholesteric liquid crystal layer having a thickness of 3.5 μm.

Coating solution 2 and Coating solution 3 were further applied in this order to the surface of the cholesteric liquid crystal layer, and the same procedure was repeated (layer of Coating solution 2, 3.0 μm; layer of Coating solution 3, 2.7 μm). In this manner, a laminate of a circularly polarized light reflecting layer (three cholesteric liquid crystal layers) was obtained. The transmission spectrum of the laminate was measured with a spectrophotometer (V-670, manufactured by JASCO Corporation) and found to have selective reflection center wavelengths at 630 nm, 540 nm, and 450 nm.

The same coating solution for barrier layer formation as in Example 1 was further applied to the surface on the cholesteric liquid crystal layer side at room temperature using a wire bar such that the dry thickness would be 3.0 μm. The coating layer was dried at room temperature for 10 seconds, heated in an atmosphere at 85° C. for 1 minute, and then irradiated with UV light at 70° C. for 5 seconds using a Fusion D-Bulb (lamp, 90 mW/cm²) at an output of 80% to obtain a laminate.

(2) The following hard coat composition was applied to a surface of the laminate opposite to the liquid crystal layer side using a wire bar. The coated laminate was then dried at 60° C. for 150 seconds, placed on a hot plate at 30° C., and irradiated with UV light for 10 seconds using a D-Bulb electrodeless lamp (60 mW/cm²) manufactured by Fusion UV Systems, Inc. to fabricate a layer having a thickness of 25 μm. In this manner, Laminate B was obtained.

### Hard Coat Composition

| | |
|---|---|
| Acrylate monomer DPHA (manufactured by | 76.5 parts by mass |
| Shin-Nakamura Chemical Co., Ltd.) | |
| Methacrylate monomer CYCLOMER M-100 | 23.5 parts by mass |
| (manufactured by Daicel Corporation) | |
| Stain-proofing agent RS-90 (manufactured by | 0.7 parts by mass |
| DIC) | |
| Inorganic particles MEK-AC-2140Z | 15.0 parts by mass |
| (manufactured by Nissan Chemical Industries, | |
| Ltd.) | |
| Polymerization initiator IRGACURE 184 | 4.0 parts by mass |
| (manufactured by BASF) | |
| Polymerization initiator PAG-1 | 1.5 parts by mass |
| Solvent (methyl ethyl ketone) | 40.0 parts by mass |
| Solvent (methyl isobutyl ketone) | 60.0 parts by mass |

(3) A Toyobo PET film (Cosmoshine A4100, 100 μm thick) was used as a temporary support (150 mm×100 mm) for quarter-wave plate fabrication. One surface thereof was subjected to rubbing treatment (rayon cloth; pressure, 0.1 kgf (0.98 N); the number of revolutions, 1,000 rpm; transport speed, 10 m/min; the number of reciprocating cycles, 1). The coating solution for quarter-wave plate formation was applied to the rubbing-treated surface of the PET film using a wire bar and then dried. The coated PET film was then placed on a hot plate at 30° C. and irradiated with UV light for 6 seconds using a D-Bulb electrodeless lamp (60 mW/cm²) manufactured by Fusion UV Systems, Inc. to fix the liquid crystalline phase, thereby forming a retardation layer having a thickness of 0.8 μm. In this manner, a quarter-wave plate with a temporary support was obtained.

(4) Using a laminator, OCA tape (MHM-FWD25 manufactured by Nichiei Kakoh Co., Ltd., 25 μm thick) was laminated to the barrier layer side of Laminate B, and then the protective film of the OCA tape was peeled off. To the peeled surface, the retardation layer surface of the quarter-wave plate with a temporary support was laminated using the laminator. Thereafter, the temporary support (PET) was peeled off the quarter-wave plate to fabricate Laminate C.

(5) A triacetyl cellulose film (FUJITAC, manufactured by FUJIFILM Corporation) having a thickness of 80 μm was immersed in a 1.5 mol/L aqueous NaOH solution at 55° C. for 2 minutes, then neutralized, and washed with water. Iodine was adsorbed on a polyvinyl alcohol film, and the film was stretched to fabricate a polarizer. To one surface of the polarizer fabricated, the triacetyl cellulose film washed with water was bonded. To the other surface of the polarizer, UV adhesive composition A having the following composition was applied using a wire bar such that the thickness after curing would be 2.5 μm.

### UV Adhesive Composition A

| | |
|---|---|
| DENACOL EX-211 (manufactured by | 100 parts by mass |
| Shin-Nakamura Chemical Co., Ltd.) | |
| WPBG-056 (manufactured by Daicel | 7.5 parts by mass |
| Corporation) | |

UV adhesive composition A was applied also to the quarter-wave plate surface of Laminate C in the same manner. Laminate C and the above polarizer were laminated together with the surfaces to which UV adhesive composition A was applied facing each other, while taking care not to trap bubbles, and the resulting laminate was irradiated with UV light for 10 seconds using a D-Bulb electrodeless lamp (60 mW/cm²) manufactured by Fusion UV Systems, Inc. In this manner, a half mirror with a polarizer was fabricated. Fabrication of Half Mirror of Example 19

### (1) Fabrication of Laminate D

A triacetyl cellulose film (FUJITAC, manufactured by FUJIFILM Corporation) was used as a support (150 mm×100 mm). A predetermined amount of 2% by mass solution of long-chain-alkyl-modified poval (MP-203, manufactured by Kuraray Co., Ltd.) was applied to the support and then dried to form an alignment resin layer. One surface thereof was subjected to rubbing treatment (rayon cloth; pressure, 0.5 kgf (4.9 N); the number of revolutions, 1,000 rpm; transport speed, 10 m/min; the number of reciprocating cycles, 1).

A quarter-wave plate, cholesteric liquid crystal layers (three layers), and a barrier layer were formed on the alignment layer side in the same manner as in Example 1 to obtain Laminate D.

### (2) Formation of Retardation Film (High-Re Retardation Film)

### Synthesis of Starting Polyesters

### Starting Polyester 1

As described below, terephthalic acid and ethylene glycol were directly reacted together to distill off water and esterified, after which Starting polyester 1 (Sb-catalyzed PET) was obtained with a continuous polymerization apparatus by using a direct esterification method in which polycondensation is performed under reduced pressure.

### Esterification Reaction

High-purity terephthalic acid in an amount of 4.7 tons and ethylene glycol in an amount of 1.8 tons were mixed together over 90 minutes to form a slurry, and the slurry was continuously fed to a first esterification reaction vessel at a flow rate of 3,800 kg/h. A solution of antimony trioxide in ethylene glycol was further continuously fed thereto, and a reaction was performed with stirring under the following conditions: temperature in reaction vessel, 250° C.; mean residence time, about 4.3 hours. During the reaction, antimony trioxide was continuously added such that the amount of Sb added was 150 ppm on an elemental basis.

The reaction product was transferred to a second esterification reaction vessel and allowed to react with stirring under the following conditions: temperature in reaction vessel, 250° C.; mean residence time, 1.2 hours. To the second esterification reaction vessel, a solution of magnesium acetate in ethylene glycol and a solution of trimethyl phosphate in ethylene glycol were continuously fed such that the amount of Mg added and the amount of P added were 65 ppm and 35 ppm, respectively, on an elemental basis.

### Polycondensation Reaction

The esterification reaction product obtained above was continuously fed to a first polycondensation reaction vessel and allowed to undergo polycondensation reaction with stirring under the following conditions: reaction temperature, 270° C.; pressure in reaction vessel, 20 torr (2.67×10⁻³ MPa); mean residence time, about 1.8 hours.

The reaction product was further transferred to a second polycondensation reaction vessel and allowed to undergo reaction (polycondensation) in this reaction vessel with stirring under the following conditions: temperature in reaction vessel, 276° C.; pressure in reaction vessel, 5 torr (6.67×10⁻⁴ MPa); residence time, about 1.2 hours.

The reaction product was then further transferred to a third polycondensation reaction vessel and allowed to undergo reaction (polycondensation) in this reaction vessel under the following conditions: temperature in reaction vessel, 278° C.; pressure in reaction vessel, 1.5 torr (2.0×10⁻⁴ MPa); residence time, 1.5 hours, thereby obtaining a reaction product (polyethylene terephthalate (PET)).

The reaction product obtained was then discharged in strand form into cold water and immediately cut to produce polyester pellets (section: major axis, about 4 mm; minor axis, about 2 mm; length, about 3 mm).

The polymer obtained had an intrinsic viscosity (IV) of 0.63. This polymer is Starting polyester 1 (hereinafter abbreviated as PET 1).

### Starting Polyester 2

A dried ultraviolet absorber (2,2′-(1,4-phenylene)bis(4H-3,1-benzoxazin-4-one) in an amount of 10 parts by mass and PET 1 (IV=0.63) in an amount of 90 parts by mass were mixed together. The mixture was then pelletized using a kneading extruder in the same manner as in the production of PET 1 to obtain Starting polyester 2 (hereinafter abbreviated as PET 2) containing the ultraviolet absorber.

### Production of Polyester Film

### Film-Forming Step

PET 1 in an amount of 90 parts by mass and 10 parts by mass of PET 2 containing the ultraviolet absorber were dried to a moisture content of 20 ppm or lower, then placed into a hopper 1 of a single-screw kneading extruder 1 having a diameter of 50 mm, and melted in the extruder 1 at 300° C. (interlayer II).

PET 1 was dried to a moisture content of 20 ppm or lower, then placed into a hopper 2 of a single-screw kneading extruder 2 having a diameter of 30 mm, and melted in the extruder 2 at 300° C. (external layer I, external layer III).

These two polymer melts were separately passed through gear pumps and filters (pore size, 20 μm), then laminated at a two-type three-layer manifold block such that the polymer extruded from the extruder 1 formed an interlayer (layer II) and the polymer extruded from the extruder 2 formed external layers (layer I and layer III), and extruded in sheet form through a die having a width of 120 mm.

The molten resin was extruded through the die under the following conditions: pressure fluctuation, 1%; molten resin temperature distribution, 2%. Specifically, the back pressure was higher than the mean pressure inside barrels of the extruders by 1%, and the pipe temperature of the extruders was higher than the mean temperature inside the barrels of the extruders by 2%.

The molten resin extruded through the die was cast onto a cooling casting drum set to a temperature of 25° C. and brought into close contact with the cooling casting drum by electrostatic application. The molten resin was stripped off using strip-off rollers oppositely disposed on the cooling casting drum to obtain an unstretched polyester film. In this process, the amount of discharge from the extruders was controlled so that the thickness ratio of layer I to layer II to layer III was 10:80:10. Furthermore, the molten resin was extruded through the die under varied conditions to obtain unstretched polyester films having different thicknesses.

### Preparation of Coating Solution H

Coating solution H having the following composition was prepared.

### Coating Solution H

| | |
|---|---|
| Water | 56.6 parts by mass |
| Acrylic resin (A1, solids content = 28% by mass) | 21.4 parts by mass |
| Carbodiimide compound: (B1, solids content = | 2.9 parts by mass |
| 40% by mass) | |
| Surfactant (E1, an aqueous solution with a solids | 8.1 parts by mass |
| content of 1% by mass) | |
| Surfactant (E2, an aqueous solution with a solids | 9.6 parts by mass |
| content of 1% by mass) | |
| Particles (F1, solids content = 40% by mass) | 0.4 parts by mass |
| Lubricant (G, solids content = 30% by mass) | 1.0 part by mass |

Details of the compounds used are given below.

Acrylic resin: (Al)

As an acrylic resin (Al), an aqueous dispersion (solids content=28% by mass) of an acrylic resin obtained by polymerization of a monomer having the following composition was used.

Emulsion polymer (emulsifier: anionic surfactant) of methyl methacrylate/styrene/2-ethylhexyl acrylate/2-hydroxyethyl methacrylate/acrylic acid=59/9/26/5/1 (mass %), Tg=45° C.

Carbodiimide compound: (B1) (CARBODILITE V-02-L2, manufactured by Nisshinbo Inc.)
Surfactant: (E1) sulfosuccinate surfactant (RAPISOL A-90, manufactured by NOF Corporation)
Surfactant: (E2) polyethylene oxide surfactant (NAROACTY CL-95, manufactured by Sanyo Chemical Industries, Ltd.)
Particles: (F1) silica sol having an average particle size of 50 nm
Lubricant: (G) carnauba wax

### Formation of Retardation Film

### Formation of Uniaxially Stretched (Transversely Stretched) Film (Retardation Film)

Coating solution H having the above composition was applied to opposite surfaces of the unstretched polyester film obtained as described above by reverse roll coating while controlling the amount of application such that the amount of dried coating would be 0.12 g/m². The resulting film was guided to a tenter (transverse stretching machine). With ends of the film held by clips, the film was preheated at 92° C. to be stretchable and stretched 4.0-fold in the width direction (stretching rate: 900%/min) to obtain a film having a width of 5 m. Next, the polyester film was heat-set and relaxed with its surface temperature controlled at 160° C. and then cooled at a cooling temperature of 50° C.

After the cooling, the polyester film was longitudinally divided into three parts each having a width of 1.4 m, and chucked portions were trimmed. Thereafter, each divided roll was pressed (knurled) at both its ends over a width of 10 mm and then wound up by 2,000 m under a tension of 18 kg/m. The divided samples were named a side edge A, a center B, and a side edge C from one side edge, and the center B was used. The retardation film obtained had a thickness of 80 μm and a front retardation, as measured with an Axoscan, of 8,060 nm.

### (3) Fabrication of Front Panel

The above hard coat composition was applied to one surface of the retardation film using a wire bar and then dried at 60° C. for 150 seconds. The coated film was then placed on a hot plate at 30° C. and irradiated with UV light for 10 seconds using a D-Bulb electrodeless lamp (60 mW/cm²) manufactured by Fusion UV Systems, Inc. to fabricate a layer having a thickness of 25 μm. In this manner, a front panel (Laminate E) was obtained.

### (4) Fabrication of Laminate F (Half Mirror)

Using a laminator, OCA tape (MHM-FWD25 manufactured by Nichiei Kakoh Co., Ltd., 25 μm thick) was laminated to the barrier layer side of Laminate D, and then the protective film of the OCA tape was peeled off. To the peeled surface, the surface of Laminate E opposite to the hard coated surface was laminated using the laminator to obtain Laminate F.

(5) Fabrication of Half Mirror with Polarizer

A triacetyl cellulose film (FUJITAC, manufactured by FUJIFILM Corporation) having a thickness of 80 μm was immersed in a 1.5 mol/L aqueous NaOH solution at 55° C. for 2 minutes, then neutralized, and washed with water. Iodine was adsorbed on a polyvinyl alcohol film, and the film was stretched to fabricate a polarizer. To one surface of the polarizer fabricated, the triacetyl cellulose film washed with water was directly attached. To the other surface of the polarizer, UV adhesive composition A was applied using a wire bar such that the thickness after curing would be 2.5 μm. UV adhesive composition A was applied also to the triacetyl cellulose surface of Laminate F in the same manner. Laminate F and the polarizer were laminated together with the surfaces to which UV adhesive composition A was applied facing each other, while taking care not to trap bubbles, and the resulting laminate was irradiated with UV light for 10 seconds using a D-Bulb electrodeless lamp (60 mW/cm²) manufactured by Fusion UV Systems, Inc. In this manner, a half mirror with a polarizer was fabricated.

### Evaluation of Half Mirror

The half mirrors obtained (in Examples 18 and 19, half mirrors with polarizers) were placed in a constant temperature and humidity box set to 110° C. and evaluated for heat resistance and crack resistance after 1,000 hours.

The evaluation of heat resistance was performed by measuring the reflectance at a light incidence angle of 25° with a spectrophotometer (V-670, manufactured by JASCO Corporation) and determining the amount of shift of the reflectance peak wavelength at or near 450 nm before and after the half mirror was placed in the constant temperature and humidity box (before and after 1,000 hours at 110° C.). The amount of shift of the reflectance peak wavelength has an influence on the change in shade of the half mirrors.

(Amount of wavelength shift=reflectance peak at or near 450 nm of sample before being placed in constant temperature and humidity box—reflectance peak at or near 450 nm of sample after 1,000 hours at 110° C.)

The evaluation of crack resistance was performed by visually checking the occurrence of cracks in the circularly polarized light reflecting layer after 1,000 hours at 110° C.

The results are shown in Table 2.

The same evaluations were made after the half mirrors were placed in the constant temperature and humidity box under the same conditions for 160 hours. The results were substantially the same.

TABLE 2

| | | Number of | | | | |
|---|---|---|---|---|---|---|
| | | polymerizable | | Barrier | Amount of | |
| | | groups | Polymerizable | layer | wavelength | Crack |
| | Monomer | (average) | group content | Tg [° C.] | shift [nm] | occurrence |
| Example 1 | U6LPA | 6 | 0.0078 | 220 or | 0 | yes |
| | | | | higher | | |
| Example 2 | U4HA | 4 | 0.01 | 220 or | 0 | no |
| | | | | higher | | |
| Example 3 | EBECRYL | 6 | 0.006 | 49 | 3 | yes |
| | 220 | | | | | |
| Example 4 | Mixture of | 4.5 | 0.00009 | 220 or | 6 | no |
| | U6LPA with | | | higher | | |
| | 8BR-600 | | | | | |
| Example 5 | Mixture of | 4 | 0.0043 | 150 | 8 | no |
| | U6LPA with | | | | | |
| | UA122P | | | | | |
| Example 6 | CEL2021P | 2 | 0.00792 | 105 | 0 | no |
| Example 7 | CEL8000 | 2 | 0.01030 | 108 | 0 | no |
| Example 8 | CYCLOMER | 1 | 0.00509 | 150 | 5 | no |
| | M100 | | | | | |
| Example 9 | EPICLON | 2 | 0.00734 | 124 | 0 | no |
| | HP-4032D | | | | | |
| Example 10 | EP4088S | 2 | 0.00649 | 38 | 6 | no |
| Example 11 | ADCP | 2 | 0.00657 | 140 | 4 | no |
| Example 12 | DPHA | 6 | 0.01038 | 220 or | 2 | yes |
| | | | | higher | | |
| Example 13 | SP-327 | 3 | 0.01013 | 220 or | 3 | no |
| | | | | higher | | |
| Example 14 | PET30 | 4 | 0.01342 | 220 or | 2 | yes |
| | | | | higher | | |
| Example 15 | DPCA20 | 6 | 0.00743 | 220 or | 0 | yes |
| | | | | higher | | |
| Example 16 | DPCA120 | 6 | 0.00308 | 0 | 5 | no |
| Example 17 | U6LPA | 6 | 0.0078 | 220 or | 0 | no |
| | | | | higher | | |
| Example 18 | U6LPA | 6 | 0.0078 | 220 or | 0 | no |
| | | | | higher | | |
| Example 19 | U6LPA | 6 | 0.0078 | 220 or | 0 | no |
| | | | | higher | | |
| Comparative | none | — | — | | 10 | yes |
| Example 1 | | | | | | |

### Interlayer Transfer of Substances

Laminate G of a quarter-wave plate and a circularly polarized light reflecting layer was obtained in the same manner as Laminate A except that in place of IRGACURE OXE01, the same amount of IRGACURE 819 (manufactured by BASF) was used as a polymerization initiator.

OCA tape (MHM-FWD25 manufactured by Nichiei Kakoh Co., Ltd., 25 μm thick) was laminated to the surface of the circularly polarized light reflecting layer of Laminate G. Thereafter, the temporary support was peeled off to obtain Sample 1.

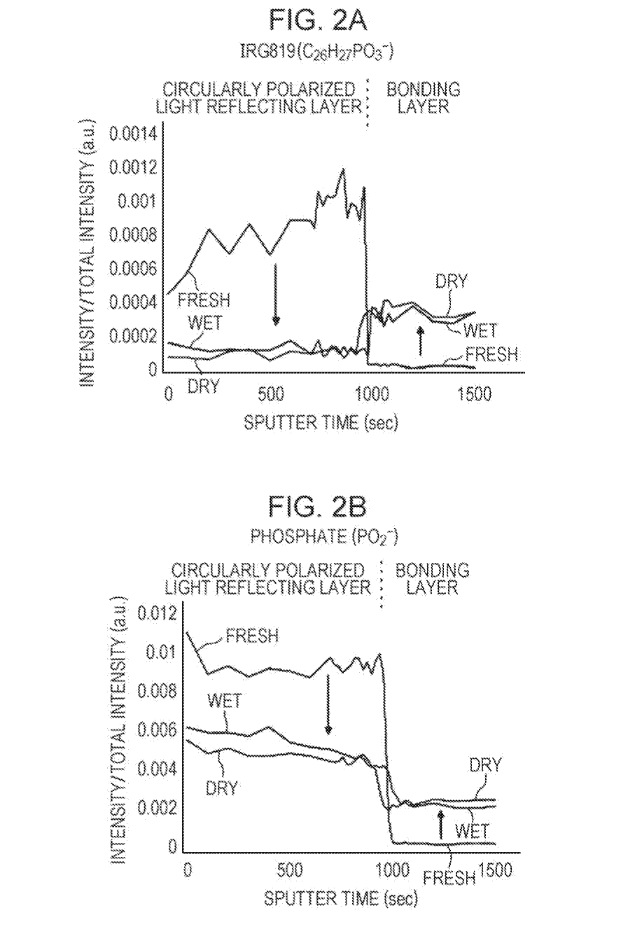

The substance distribution of Sample 1 before and after environmental testing was analyzed by TOF-SIMS (TOF-SIMS IV manufactured by ION-TOF GmbH). The environmental testing was performed by leaving the sample to stand in a constant temperature and humidity box. The conditions for leaving the sample to stand were at 110° C. for 160 hours and at 85° C. and a relative humidity of 85% for 160 hours. Focusing on substances contained in the composition forming the cholesteric liquid crystal layer, i.e., the chiral agent, the polymerizable liquid crystal compound, and the polymerization initiator described above, Sample 1 was subjected to TOF analysis while being cut in the depth direction (thickness direction). The results are shown in FIGS. 2A and 2B. In FIGS. 2A and 2B, the abscissa is the cutting time, corresponding to the depth, and the ordinate is the signal intensity of ions observed (corresponding to the amount of substance). In FIGS. 2A and 2B, “Fresh” is the analysis result before environmental testing, “wet” is the analysis result after environmental testing at 85° C. and a relative humidity of 85% for 160 hours, and “dry” is the analysis result after environmental testing at 110° C. for 160 hours. FIGS. 2A and 2B show that the polymerization initiator IRGACURE 819 (C₂₆H₂₇PO₃⁻) and the decomposition product thereof (PO₂⁻) transferred to the adhesive layer of OCA, i.e., the bonding layer.

Sample 2 was fabricated by the same procedure except that Laminate G was replaced with Laminate A. Sample 2 was analyzed similarly by TOF-SIMS, revealing that the polymerization initiator IRGACURE OXE01 and the decomposition product thereof transferred as with Sample 1.

A coating solution for barrier layer formation having the following composition was applied to the surface of the circularly polarized light reflecting layer of Laminate G at room temperature using a wire bar such that the dry thickness would be 3.0 μm. The coating layer was dried at room temperature for 10 seconds, heated in an atmosphere at 85° C. for 1 minute, and then irradiated with UV light at 70° C. for 5 seconds using a Fusion D-Bulb (lamp, 90 mW/cm²) at an output of 80% to obtain a barrier layer. OCA (MHM-FWD25 manufactured by Nichiei Kakoh Co., Ltd., 25 μm thick) was laminated to the surface on the barrier layer side. Thereafter, the temporary support was peeled off to obtain Sample 3.

Urethane (meth)acrylate monomer U6LPA 100 parts by mass
Polymeric surfactant B1176 (manufactured by DIC Corporation) 0.05 parts by mass
Polymerization initiator IRGACURE OXE01 (manufactured by BASF) 1.0 part by mass
Solvent (methyl ethyl ketone) an amount to provide a solute concentration of 40% by mass

Sample 3 was analyzed similarly by TOF-SIMS, but no data were obtained showing the transfer of the chiral agent, the polymerizable liquid crystal compound, the polymerization initiator, or the decomposition product of any of them.

### REFERENCE SIGNS LIST

1 circularly polarized light reflecting layer

2 bonding layer (bonding layer in contact with barrier layer)

3 front panel

4 barrier layer

5 quarter-wave plate

6 polarizer

10 support

11 alignment layer

12 other bonding layer

16 polarizer-protective layer

21 glass plate or plastic film

22 high-Re retardation film

23 optically functional layer

What is claimed is:

1. A half mirror comprising:
a circularly polarized light reflecting layer including a cholesteric liquid crystal layer;
a barrier layer;
a bonding layer; and
a front panel,
wherein the barrier layer is disposed between the bonding layer and the circularly polarized light reflecting layer.

2. The half mirror according to claim 1, wherein the circularly polarized light reflecting layer and the barrier layer are in direct contact with each other.

3. The half mirror according to claim 1, wherein the cholesteric liquid crystal layer is a layer formed by curing a liquid crystal composition containing a polymerizable liquid crystal compound and a polymerization initiator.

4. The half mirror according to claim 2, wherein the cholesteric liquid crystal layer is a layer formed by curing a liquid crystal composition containing a polymerizable liquid crystal compound and a polymerization initiator.

5. The half mirror according to claim 3, wherein the polymerization initiator is an acylphosphine oxide compound or an oxime compound.

6. The half mirror according to claim 4, wherein the polymerization initiator is an acylphosphine oxide compound or an oxime compound.

7. The half mirror according to claim 1, wherein the bonding layer is formed of a sheet-shaped adhesive.

8. The half mirror according to claim 1, wherein the barrier layer is a layer formed by curing a composition containing a polymerizable-group-containing monomer.

9. The half mirror according to claim 8, wherein Y₁ and X₁ satisfy inequality 1:
Y₁<−300X₁+7.5 (1)
wherein Y₁ is a number of polymerizable groups in the monomer, and X₁ is a polymerizable group content calculated by dividing the number of polymerizable groups Y₁ by a molecular weight of the monomer.

10. The half mirror according to claim 8, wherein the monomer is at least one monomer selected from the group consisting of urethane (meth)acrylate monomers and epoxy monomers.

11. The half mirror according to claim 9, wherein the monomer is at least one monomer selected from the group consisting of urethane (meth)acrylate monomers and epoxy monomers.

12. The half mirror according to claim 8, wherein the monomer is a urethane (meth)acrylate monomer, and
the composition contains a urethane polymer.

13. The half mirror according to claim 8, wherein the monomer is a urethane (meth)acrylate monomer, and
Y₂ and X₂ satisfy inequality 2:
Y₂>−0.0066X₂+5.33 (2)
wherein Y₂ is a number of polymerizable groups in the urethane (meth)acrylate monomer, and X₂ is a glass transition temperature of the composition.

14. The half mirror according to claim 8, wherein the monomer is an epoxy monomer, and Y₃ and X₃ satisfy inequality 3:
Y₃>−0.01X₃+2.75 (3)
wherein Y₃ is a number of polymerizable groups in the epoxy monomer, and X₃ is a glass transition temperature of the composition.

15. The half mirror according to claim 1, wherein the circularly polarized light reflecting layer includes three or more cholesteric liquid crystal layers.

16. The half mirror according to claim 1, further comprising a quarter-wave plate,
wherein the quarter-wave plate, the circularly polarized light reflecting layer, and the front panel are disposed in this order.

17. The half mirror according to claim 16, wherein the circularly polarized light reflecting layer and the quarter-wave plate are in direct contact with each other.

18. A mirror with an image display function, the mirror comprising:
the half mirror according to claim 1; and
an image display device,
wherein the image display device, the circularly polarized light reflecting layer, and the front panel are disposed in this order.

19. The mirror with an image display function according to claim 18, wherein the mirror is used for a vehicle.
